(19) United States
(12) Patent Application Publication
(10) Pub. No.: US 2007/0283525 A1
(43) Pub. Date: Dec. 13, 2007

(54) Extension spring door kit

(75) Inventors: Francois Beaudoin, Drummondville (CA); Pascal Provencher, Drummondville (CA)

Correspondence Address: MERCHANT & GOULD PC, P.O. BOX 2903, MINNEAPOLIS, MN, 55402-0903, US

(73) Assignee: CANIMEX INC., Drummondville (CA)

(21) Appl. No.: 11/796,468

(22) Filed: Apr. 27, 2007

Related U.S. Application Data
(60) Provisional application No. 60/795,178, filed on Apr. 27, 2006.

(51) Int. Cl. E05F 1/00

(52) U.S. Cl. 16/81

(57) ABSTRACT

A kit (1) for assembling a variety of different door configurations adapted to be installed within a predetermined range of dimensions, onto a specific door opening (7) defined within a fixed structure (9) and contained within said predetermined range of dimensions. The kit (1) includes first components (11) for assembling a specific door leaf (13) shaped and sized for substantially covering the specific door opening (7). The kit (1) also includes second components (15) for mounting onto the fixed structure (9) of the specific door opening (7), the second components (15) including components (15) for assembling a track system (17) along which the specific door leaf (13) is configured to travel. The kit (1) also includes third components (19) for assembling a counterbalancing system (21) operatively connectable between the specific door leaf (13) and the fixed structure (9) for counterbalancing the specific door leaf (13) with respect to said fixed structure (9). The components (11,15,19) of the kit (1) are configured to be selectively adjustable along given increments for assembling a specific door assembly (23) representative of dimensions (25,27) of the specific door opening (7), and the components (11,15,19) of the kit (1) are further configured to be provided with adjustment means (29), and corresponding marking systems (31) representative of given increments, for selectively adjusting parameters of the components (11,15,19) of the kit (1) in response to the specific door leaf (13) being used for assembling the specific door assembly (23).

### FIELD OF THE INVENTION

The present invention relates to the field of kits used for assembling door assemblies and the like. More particularly, and in its preferred intended use, the present invention relates to an extension spring door kit for assembling door assemblies and the like, as well as to a door assembly having been assembled with such kit, and to a method of assembling associated thereto.

### BACKGROUND OF THE INVENTION

Door assemblies, kits used for assembling the same, and components to be used therewith, are well known in the art. Some of which are disclosed in the following US patents and/or patent applications: U.S. Pat. Nos. 2,064,470; 2,516,196; 2,951,533; 3,555,590; 3,734,161; 4,460,030; 4,878,529; 5,555,923; 5,626,176; 5,782,283; 6,047,761; 6,055,885; 6,591,551 B2; 6,672,362 B1; 7,059,379 B2; 2003/0173039 A1; 2003/0205340 A1; 2003/0213566 A1; and 2006/0201639 A1.

Also known to the Applicant are the following foreign patents and/or patent applications: EP 1,314,847 A2; JP 2001003657 A; and JP 2004116001A.

It is also known in the art that articulated or sectional overhead doors are often preferred to unarticulated overhead doors because they require less space inside a building when opened and closed. Typically, they occupy less space above the doorway's lintel, when compared to a roll-up door, and they are also easier to handle than vertically or horizontally swinging doors, which require substantial space both inside and sometimes outside the building.

Often, existing solutions focus on the overhead space and side room space, or on specific technical solutions regarding various functions of a sectional overhead door with conventional helical tension springs. These existing solutions generally differ from manufacturers in a way that they accomplish the same goal, but with different technical solutions.

Solutions to reduce the overhead space or the side room space are omnipresent in the garage door industry. Some of them are described in patents known to the Applicant, as can be seen in the following examples:

Indeed, it is already known in the art that there are ways to reduce significantly the overhead space, as can be read in U.S. Pat. No. 6,073,674 (HÖRMANN). These means generally relate to the location of the helical tension springs, and to a method of specifically attaching them to the door structure.

It is also known in the art that there are ways to reduce the required space for the helical tension springs, as can be read in U.S. Pat. No. 6,122,862 (HÖRMANN). These means generally concern the disposition of the helical tension springs by having one spring in the other with a specific construction method.

It is also known in the art that there are ways to reduce the required overhead space for Horizontal track sets, as can be read in International application No. WO02/072992A1 (OLSSON). These means generally concern the geometry of the track which is made so that two rollers can travel in the same part, but with the head of a concerned roller pointing in an opposite direction.

Other specific technical solutions are covered by many other patents and/or patent applications, of which are the following examples:

Known in the art are ways to reduce the packing space for a track system and at the same time increasing rigidity of the track system, as can be read in EP patent No. 1,010,850 B1 (HÖRMANN). These means generally concern the way to overlap at least one end of the curved shape guide rail member over either the vertical guide rail member or the horizontal guide rail member.

It is also known in the art that there are ways to prevent the top panel to move into the garage under wind pressure or other sources of pressure, as can be read in U.S. Pat. No. 6,076,589 (HÖRMANN). These means generally concern the geometry of a track member and the addition of a flat spring to ease the movement of the door. One important aspect of this prior art document concerns the possibility to use the same parts for manual operated doors, and electric operated doors, at the exception of one small and inexpensive parts.

It is also known in the art that there are ways to hold the door in the opened position, as can be read in EP patent Nos. 1,010,851 B1 (HÖRMANN) and 0,495,449 B1 (HÖRMANN). These means generally concern devices whose function is to catch the topmost rollers and to hold them so the door stays in its fully opened position.

It is also known in the art that there are ways to adjust roller holders, as can be read in DE patent No. 102 26 836 A1 (GROHS). These means generally concern having a roller fixed in a way that its rotation over a fixed axis will move said roller perpendicular to a plane parallel to the garage opening.

It is also known in the art that there are ways to adjust the helical tension spring tension, as can be read in DE utility model No. 29906444 U1. These means generally consist in having a spring attachment solidly fixed to a threaded shaft so that the only link with the spring's housing is a threaded hole. The rotation of said threaded shaft results in the movement of the threaded shaft along its own axis, thus moving the helical tension spring.

It is also known in the art that there are ways to limit the speed of the top panel of the door leaf, as can be read in EP patent application No. 1,467,053 A1 (OLSSON). These means generally concern a way to assemble a friction brake to the top panel so that the relative position of said panel to the track bend triggers the friction brake and thus reduces the speed of the top panel.

As it can be seen, there are many existing solutions regarding devices to save overhead space, side room space and/or other technical aspects of a door, as described above, but none of these solutions are related to a specific and important aspect: versatility of a given and same door kit due to the design of its components and features so as to cover a wide range of possible door assemblies while lowering complexity of shipping and handling of the components and features of said kit.

Indeed, in the current situation of the garage door industry, more specifically in Europe, the market is very fragmented and the trend is confirming this situation. In other words, there are many door system builders which are distributors or installers. Among these groups, there are few large corporations, but many small regional door system builders.

In such a reality, standardisation is the key factor to deliver a very economical solution to the small door system builders. The standardisation is described as follows for this type of door construction: a) fewer color options; b) limited dimension ranges; c) various panel manufacturer compatibilities; and d) universal hardware kits including horizontal track sets, vertical track sets, distance beam, cosmetic lintel, spring boxes, a lock kit and all the hardware needed for the interconnection of the door leaf altogether and the whole track system to the building structure.

All existing and conventional solutions are generating a large amount of stock keeping units (SKU's) for door system builders. This is because there is no combined solution or kit available to adjust all of the following parameters: the cable length, the spring tension, the hinges, the vertical track, the cosmetic lintel and the distance beam altogether on the installation site. Indeed, any modification made to door dimensions, whether width or height, will result in dedicated parts for each portion of the hardware kit, as described above.

In addition, all installation companies have limited storage space so they cannot afford to have hardware kits of every door dimension. Such a scenario would require them to stock up a great number of doors per color and surface finish, etc., which is absolutely not possible for many of these companies, and also very undesirable for obvious reasons known in the art.

Hence, in light of the aforementioned, there is a need for a door kit, which by virtue of its design and components, would be able to overcome some of the above-discussed prior art problems.

### SUMMARY OF THE INVENTION

The object of the present invention is to provide a door kit, which by virtue of its design and components, satisfies some of the above-mentioned needs and is thus an improvement over other related kits, devices and/or methods known in the prior art.

In accordance with the present invention, the above object is achieved, as will be easily understood, with a door kit, such as the one briefly described herein, and such as the one exemplified in the accompanying drawings.

More particularly, according to the present invention, there is provided a kit for assembling a variety of different door configurations adapted to be installed within a predetermined range of dimensions, onto a specific door opening defined within a fixed structure and contained within said predetermined range of dimensions, the kit comprising:

first components for assembling a specific door leaf shaped and sized for substantially covering the specific door opening;

second components for mounting onto the fixed structure of the specific door opening, the second components including components for assembling a track system along which the specific door leaf is configured to travel; and

third components for assembling a counterbalancing system operatively connectable between the specific door leaf and the fixed structure for counterbalancing the specific door leaf with respect to said fixed structure;

the components of the kit being configured to be selectively adjustable along given increments for assembling a specific door assembly representative of dimensions of the specific door opening, and the components of the kit being further configured to be provided with adjustment means, and corresponding marking systems representative of given increments, for selectively adjusting parameters of the components of the kit in response to the specific door leaf being used for assembling the specific door assembly.

According to yet another aspect of the present invention there is also provided a door assembly (e.g. a garage door, overhead door, etc.) assembled with the above-mentioned kit.

According to yet another aspect of the present invention there is also provided a method for assembling the above-mentioned kit and/or door assembly.

According to yet another aspect of the present invention there is also provided a method of packaging the above-mentioned kit and/or door assembly.

The objects, advantages and other features of the present invention will become more apparent upon reading of the following non-restrictive description of preferred embodiments thereof, given for the purpose of exemplification only with reference to the accompanying drawings.

### BRIEF DESCRIPTION OF THE DRAWINGS

FIG. 1 is a perspective view of an overhead sectional door assembly having been assembled with a kit according to a preferred embodiment of the present invention.

FIG. 2 is a top cross-sectional view of a door opening within a fixed structure provided with vertical angle sets, side sealings and tracks according to a preferred embodiment of the present invention.

FIG. 3 is a side cross-sectional view of a door opening within a fixed structure provided with a cosmetic lintel and side sealing according to a preferred embodiment of the present invention.

FIG. 4 is a partial perspective view of a door leaf according to a preferred embodiment of the present invention.

FIG. 5 is a schematic representation of a door leaf according to a preferred embodiment of the present invention.

FIG. 6 is an exploded view of an end cap destined to be mounted onto a corresponding sectional panel of a door leaf according to a preferred embodiment of the present invention, said sectional panel being shown rested on a support structure.

FIG. 7 is a perspective view of a spring box according to a preferred embodiment of the present invention, a cable of the counterbalancing system being shown cooperating with a pulley of said spring box.

FIG. 8 is a partial perspective view of a track system provided with a rotating device intended to receive an extremity of a cable of the counterbalancing system according to a preferred embodiment of the present invention.

FIG. 9 is a side view of a spring box according to another preferred embodiment of the present invention.

FIG. 10 is a top view of what is shown in FIG. 9.

FIG. 11 is another side view of a spring box according to yet another preferred embodiment of the present invention, said spring box being shown with a cable of the counterbalancing system cooperating with a pulley of said spring box.

FIG. 12 is a top cross-sectional view of what is shown in FIG. 11.

FIG. 13 is a top view of what is shown in FIG. 11, and better illustrating the marking system including windows of said spring box.

FIG. 14 is a partial elevational view of a vertical angle set provided with a side sealing and corresponding vertical track according to a preferred embodiment of the present invention.

FIG. 15 is another perspective view of what is shown in FIG. 14.

FIG. 16 is a partial elevational view of a vertical angle set provided with a side sealing and corresponding vertical track according to yet another preferred embodiment of the present invention.

FIG. 17 is a partial perspective view of a track system provided with marking systems according to a preferred embodiment of the present invention.

FIG. 18 is a partial perspective view of a portion of the track system including adjustment means cooperating with corresponding marking systems of the track system according to a preferred embodiment of the present invention.

FIG. 19 is a perspective view of a cosmetic lintel provided with marking systems according to a preferred embodiment of the present invention.

FIG. 20 is a partial exploded view of a distance beam intended to cooperate with a corresponding track system of the kit according to the present invention.

FIG. 21 is a partial perspective view of a distance beam provided with corresponding marking systems and cooperating with a track system according to a preferred embodiment of the present invention.

FIG. 22 is a perspective view of a lock assembly according to a preferred embodiment of the present invention.

FIG. 23 is an exploded view of a lock assembly according to yet another preferred embodiment of the present invention.

FIG. 24 is a partial perspective view of a lock assembly according to yet another preferred embodiment of the present invention.

FIG. 25 is a partial perspective view of components to be used with a lock assembly according to yet another preferred embodiment of the present invention.

FIG. 26 is a perspective view of a packaging method according to a preferred embodiment of the present invention.

FIG. 27 is an exploded view of an auxiliary shipping box to be nested into a main shipping box according to a preferred embodiment of the present invention.

FIG. 28 is a perspective view of a packaging method according to yet another preferred embodiment of the present invention, said packaging method providing sectional panels for assembling a door leaf of the door assembly.

FIG. 29 is a partial perspective view of a door assembly having been assembled with a kit according to a preferred embodiment of the present invention, said view better illustrating vertical, curved and horizontal sections of a main lateral track, as well as transitional and horizontal sections of a complementary lateral track, as well as a cosmetic lintel of the kit.

### DETAILED DESCRIPTION OF PREFERRED EMBODIMENTS OF THE INVENTION

In the following description, the same numerical references refer to similar elements. The embodiments shown in the figures are preferred.

In the context of the present description, the expression “garage door” includes all types of cable-operated or sectional doors and the like, including access openings, using at least one extension or torsion spring for counterbalancing the weight of the given door. Although the present invention was primarily designed for a sectional garage door, it may be used with other kinds of doors, or with any other items using a counterbalancing system, as apparent to a person skilled in the art. For this reason, the expression “garage door” or “sectional” should not be taken as to limit the scope of the present invention and includes all other kinds of doors or items with which the present invention may be used and could be useful.

Moreover, in the context of the present description, the expressions “garage” and “door”, “torsion spring”, “torsional spring”, “extension spring” and “helical spring”, “track” and “set”, “counterbalancing mechanism” and “counterbalancing system”, as well as any other equivalent expressions and/or compound words thereof, may be used interchangeably. The same applies for any other mutually equivalent expressions, such as “plate” and “bracket” for example, as well as “kit” and “product”, or even “door” and “leaf”, as apparent to a person skilled in the art.

In addition, although the preferred embodiment of the present invention as illustrated in the accompanying drawings comprises various components, etc., and although the preferred embodiment of the door kit 1 and corresponding parts of the present invention as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the door kit 1 according to the present invention, as will be briefly explained herein and as can be easily inferred herefrom by a person skilled in the art, without departing from the scope of the invention.

Broadly described, the door kit 1 and door assembly 23 to be assembled therewith according to the present invention, as exemplified in the accompanying drawings, is not necessarily limited to garage doors, as aforementioned, and as can be easily understood by a person skilled in the art, in view of the present description.

Indeed, the present invention concerns a kit 1 for assembling a variety of different door configurations adapted to be installed within a predetermined range of dimensions, onto a specific door opening 7 defined within a fixed structure 9 and contained within said predetermined range of dimensions, the kit 1 comprising: first components 11 for assembling a specific door leaf 13 shaped and sized for substantially covering the specific door opening 7; second components 15 for mounting onto the fixed structure 9 of the specific door opening 7, the second components 15 including components 15 for assembling a track system 17 along which the specific door leaf 13 is configured to travel; and third components 19 for assembling a counterbalancing system 21 operatively connectable between the specific door leaf 13 and the fixed structure 9 for counterbalancing the specific door leaf 13 with respect to said fixed structure 9. According to the present invention, the components 11,15,19 of the kit 1 are configured to be selectively adjustable along given increments for assembling a specific door assembly 23 representative of dimensions 25,27 of the specific door opening 7, and the components 11,15,19 of the kit 1 are further configured to be provided with adjustment means 29, and corresponding marking systems 31 representative of given increments, for selectively adjusting parameters of the components 11,15,19 of the kit 1 in response to the specific door leaf 13 being used for assembling the specific door assembly 23.

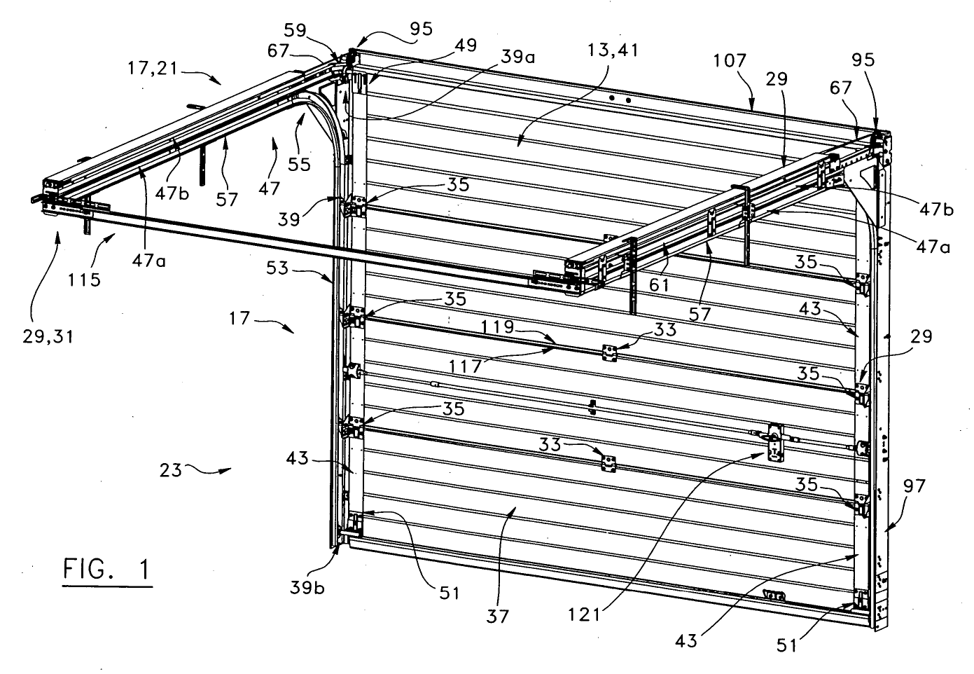

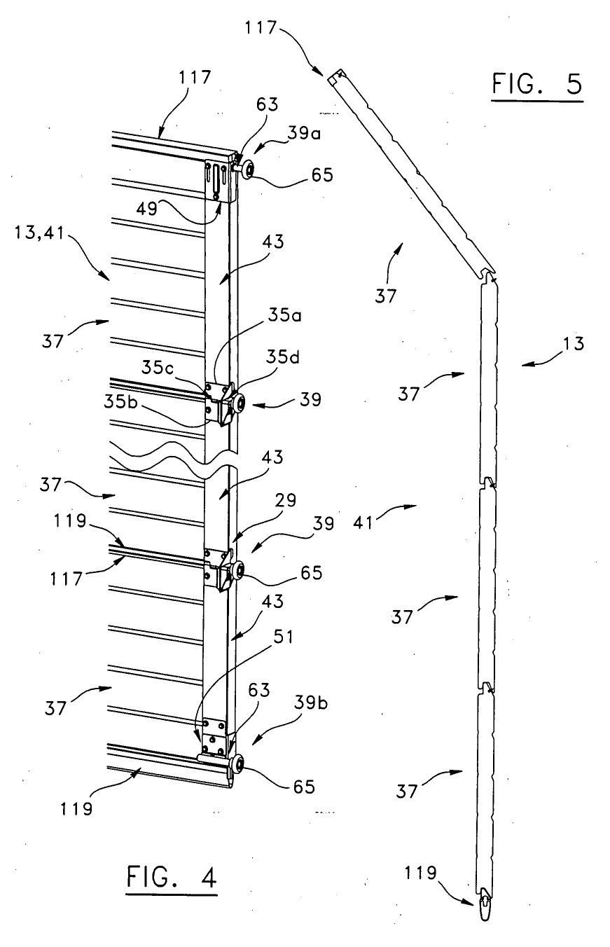

As better shown in FIGS. 1 and 4, the first components 11 of the kit 1 comprise hinges 33,35 for interconnecting sectional panels 37 so as to form the specific door leaf 13 to be used for the specific door assembly 23. The hinges 33,35 comprise intermediate and adjustable hinges 33,35, the adjustable hinges 35 being mountable adjacent to side edges of the specific door leaf 13 and having each an adjustable component for receiving a corresponding roller 39 configured for traveling along the track system 17. The adjustable component of each adjustable hinge 35 is displaceable with respect to said adjustable hinge 35 in a direction substantially perpendicular to an inner surface 41 of the specific door leaf 13 when each adjustable hinge 35 is mounted onto said specific door leaf 13.

Preferably also, and as better shown in FIG. 4, each adjustable hinge 35 comprises a top hinge 35a, a bottom hinge 35b hingedly connected to the top hinge via a pivot point 35c, and a roller holder 35d operatively connected to the pivot point 35c for holding a roller 39, the roller holder 35d being displaceable with respect to said pivot point 35c for adjustably varying a distance between a pivot axis of the roller 39 and an inner surface 41 of the specific door leaf 13 depending on the specific door assembly 23 being assembled with the kit 1. Each adjustable hinge 35 is preferably adjusted depending on a given angle of an upright portion of the track system 17, as can be easily understood by a person skilled in the art.

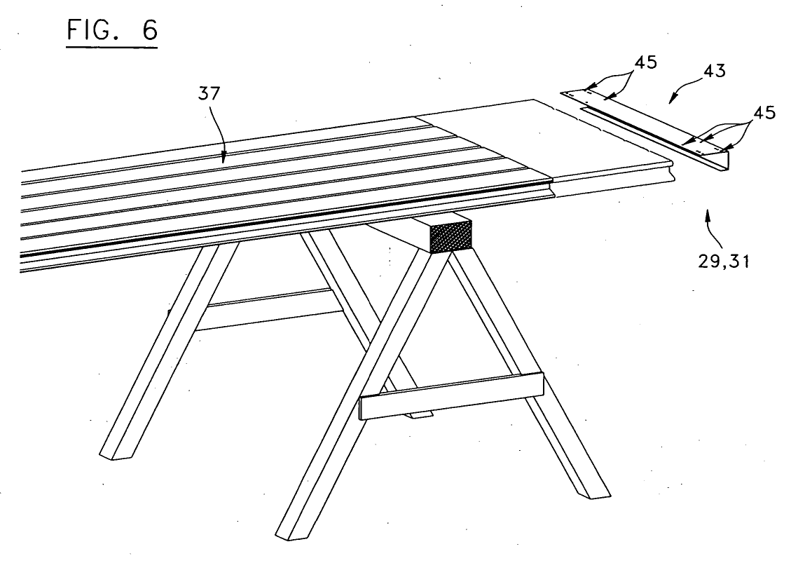

As better shown in FIG. 6, the first components 11 comprise ends caps 43 removably mountable onto side edges of sectional panels 37 for varying the effective width dimensions of said sectional panels 37 in order to adjustably form the specific door leaf 13 depending on the dimensions of the specific door opening 7. The end caps 43 are preferably provided with holes 45 for receiving corresponding fasteners so as to securely fasten the ends caps 43 onto the sectional panels 37. Hinges 35 of the kit 1 are securely mountable onto the end caps 43, as better shown in FIGS. 1 and 4.

Preferably also, the first components 11 comprise rollers 39 operatively mountable onto side edges of the specific door leaf 13 for guiding said specific door leaf 13 along corresponding tracks 47 of the track system 17, as better shown in FIG. 1.

Preferably also, the first components 11 comprise top corner brackets 49 mountable onto upper corners of the specific door leaf 13 for receiving corresponding top rollers 39a configured for traveling along the track system 17. The first components 11 also preferably comprise bottom corner brackets 51 mountable onto lower corners of the specific door leaf 13 for receiving corresponding bottom rollers 39b configured for traveling along the track system 17.

As also shown in FIG. 1, the track system 17 preferably comprises a pair of main lateral tracks 17a along which opposite side edges of the specific door leaf 13 are configured to travel via corresponding rollers 39. Each main lateral track 47a preferably comprises a vertical section 53, a curved section 55 and a horizontal section 57, said sections 53,55,57 being connectable to one another so as to define a continuous main lateral track 47a along which the corresponding rollers 39 of the specific door leaf 13 are adapted to travel.

The track system 17 also preferably comprises a pair of complementary lateral tracks 47b along which opposite and upper portions of side edges of the specific door leaf 13 are configured to travel via corresponding top rollers 39a. Each complementary lateral track 47b comprises a transitional section 59 and a horizontal section 61, said sections 59,61 being connectable to one another so as to define a continuous complementary lateral track 47b along which the corresponding top rollers 39a of the specific door leaf 13 are adapted to travel. Each complementary lateral track 47b is preferably connectable on top of and in parallel to a corresponding main lateral track 47a of the track system 17, as better shown in FIGS. 1, 17, 18, 20 and 21.

As better shown in FIG. 4, each roller 39 of the kit 1 preferably comprises a shaft 63 mountable onto a corresponding bracket 35,49,51 of the specific door leaf 13, and a head 65 rotatably mounted about said shaft 63.

Preferably also, the counterbalancing system 21 comprises at least one cable 67 having a first extremity operatively connectable to a corresponding component of the specific door leaf 13 and a second extremity operatively connectable to a corresponding component of the track system 17, as can be easily understood by a person skilled in the art.

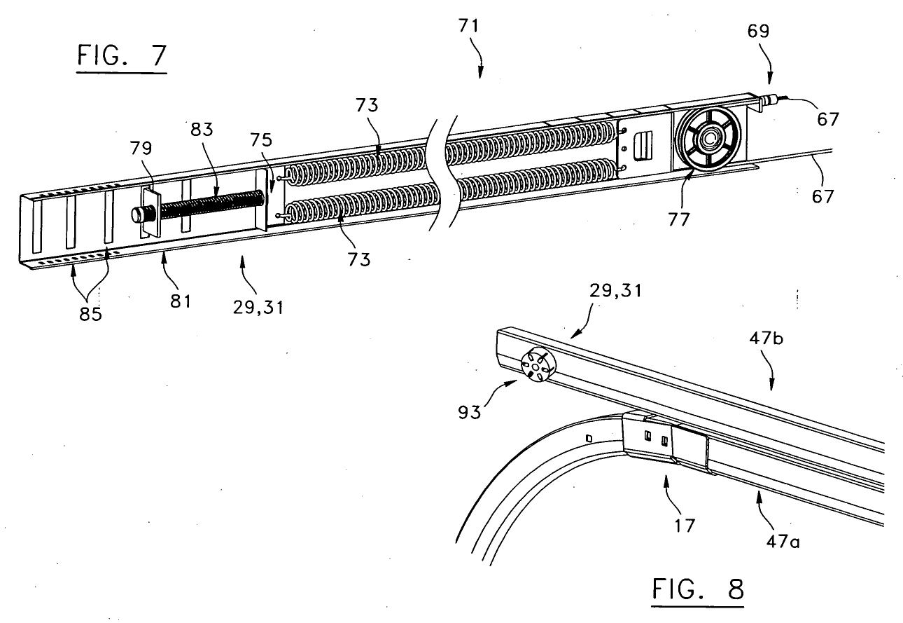

According to a first preferred embodiment of the present invention, the second extremity of the at least one cable 67 is removably securable onto said corresponding component of the track system 17 via a one-way locking sleeve 69, as better shown in FIG. 7.

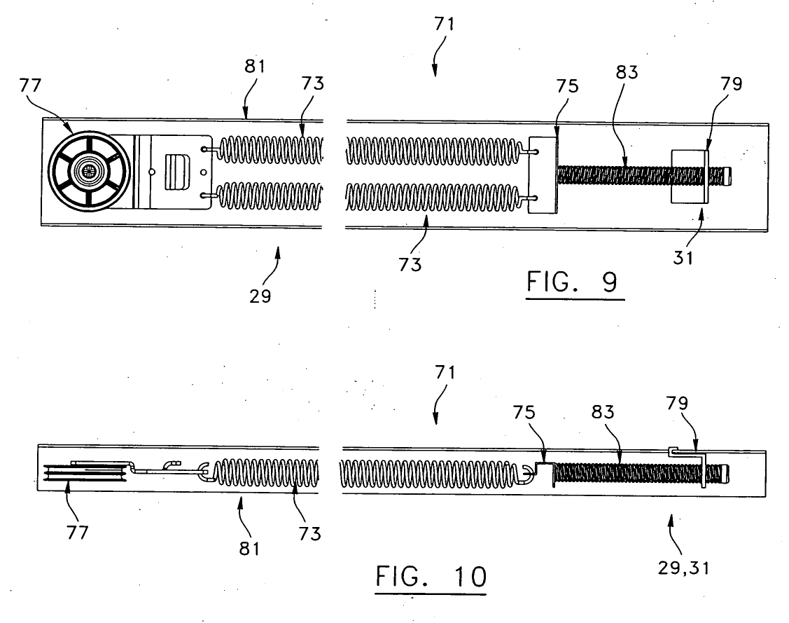

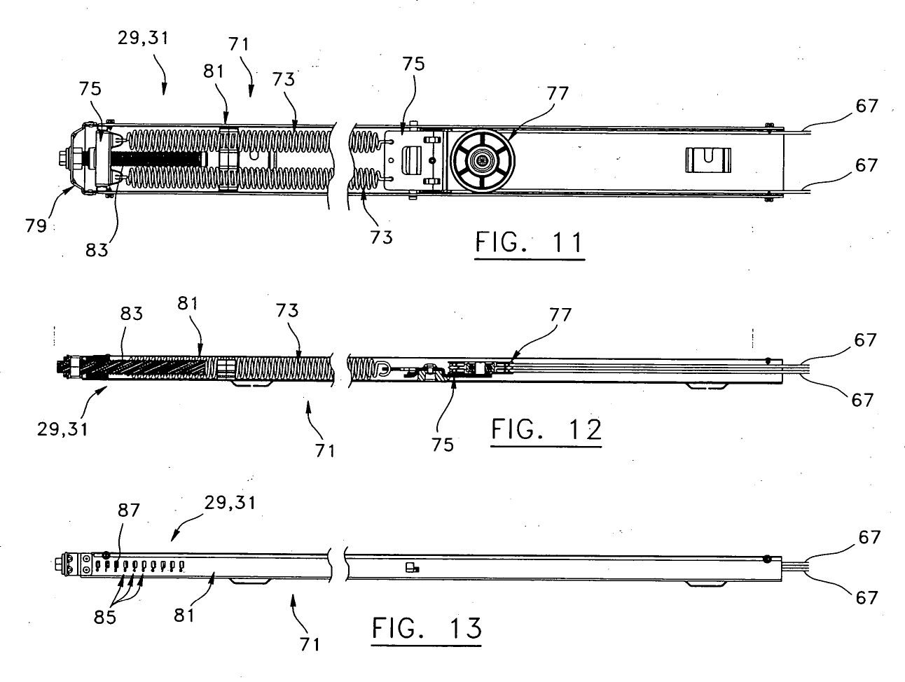

According to another preferred embodiment of the present invention, and as can be easily understood when referring to FIGS. 7-13, a portion of the at least one cable 67 is cooperable with a spring box 71, said spring box 71 having a component being deformable and capable of storing potential energy via a corresponding deformation so as operatively counterbalance the specific door leaf 13. Preferably, the spring box 71 is removably mountable and adjustably displaceable along a corresponding track 47 of the track system 17 so as to adjustably vary an effective length in the at least one cable 67, as can be easily understood by a person skilled in the art.

Preferably also, the spring box 71 comprises at least one helical tension spring 73 having a first end provided with a displaceable bracket 75 and a second end provided with a pulley 77 cooperating with a portion of the at least one cable 67.

According to another preferred embodiment of the present invention, the spring box 71 comprises an anchor bracket 79 securely mounted onto a housing 81 of the spring box 71, said anchor bracket 79 having a hole for receiving therethrough a corresponding threaded shaft 83, said threaded shaft 83 being threadedly engaged with either one of the brackets 75,79 and configured with the anchor bracket 79 such that a rotation of the threaded shaft 83 causes the displaceable bracket 75 to be displaced with respect to the anchor bracket 79, thereby adjusting the effective length of the at least one helical tension spring 73 and in turn adjusting the corresponding tension in the at least one cable 67, as can be easily understood by a person skilled in the art when referring to FIGS. 7-13.

Preferably, and as shown in FIGS. 7-13, the housing 81 of the spring box 71 comprises a marking system 31 with given increments each being representative of a given tension to be used for counterbalancing the specific door leaf 13 of the specific door assembly 23 to be assembled with the kit. The marking system 31 of the spring box 71 preferably comprises a series of windows 85 corresponding to given increments of tension, the displaceable bracket 75 being positionable along one of said windows 85 so as to vary the effective length of the at least one helical tension spring 73 and in turn adjust the corresponding tension in the at least one cable 67 for the specific door leaf 13 to be used with the specific door assembly 23 to be assembled with the kit 1. The displaceable bracket 75 is preferably provided with a clip 87 removably insertable into the windows 85 of the marking system 31 of the spring box 71. The at least one helical tension spring 73 preferably comprises a pair of helical tension springs 73 for each spring box 71, although other suitable configurations may be provided according to the present invention, as apparent to a person skilled in the art.

Preferably also, the second extremity of the at least one cable 67 is connected to a corresponding component of the track system 17, said corresponding component of the track system 17 comprising a marking system 31 with given increments, said corresponding component of the track system 17 being removably mountable onto one of said increments so as to provide a specific effective length in the at least one cable 67 of the counterbalancing system 21 in response to the specific door leaf 13 to be used with the specific door assembly 23 to be assembled with the kit 1.

According to a preferred embodiment of the present invention and as better shown in FIG. 18 for example, the corresponding component of the track system 17 comprises a cable attachment bracket 89 removably mountable onto a corresponding track 47 of the track system 17. Preferably, the cable attachment bracket 89 is provided with a rotating clip 91 for receiving the second extremity of the at least one cable 67, and for advantageously enabling to balance the tension in the cables 67 of the door assembly 23, as can be easily understood by a person skilled in the art.

According to another preferred embodiment of the present invention, the corresponding component of the track system 17 may comprise a rotating device 93 removably mountable onto a corresponding track 47 of the track system 17, the second extremity of the at least one cable 67 being connected to said rotating device 93 and a portion of said at least one cable 67 being woundable about the rotating device 93 for adjustably varying the effective length in the at least one cable 67 to be used for counterbalancing the specific door leaf 13 of the specific door assembly 23 to be assembled with the kit 1. The rotating device 93 comprises a marking system 31 with given increments each being representative of a given length or tension to be used for counterbalancing the specific door leaf 13 of the specific door assembly 23 to be assembled with the kit 1.

As can be easily understood by a person skilled in the art when referring to FIG. 1, the third components comprise at least one pulley 95 mountable onto a corresponding section of the track system 17 and cooperable with a portion of the at least one cable 67.

According to the preferred embodiment of the present invention, the at least one cable 67 comprises a cable length dimensioned so as to cover all the different door configurations possible with the kit 1. Preferably also, the kit 1 comprises a pair of said at least one cables 67, each cable 67 being used for counterbalancing a corresponding side of the specific door leaf 13.

Also according to a preferred embodiment of the present invention, the predetermined range of dimensions of the kit 1 comprises a height dimension ranging from about 1000 mm to about 3000 mm, and a width dimension ranging from about 1000 mm to about 5000 mm. More particularly, the predetermined range of dimensions preferably comprises a height dimension ranging from about 1875 mm to about 2125 mm, and a width dimension ranging from about 2125 to about 2500 mm.

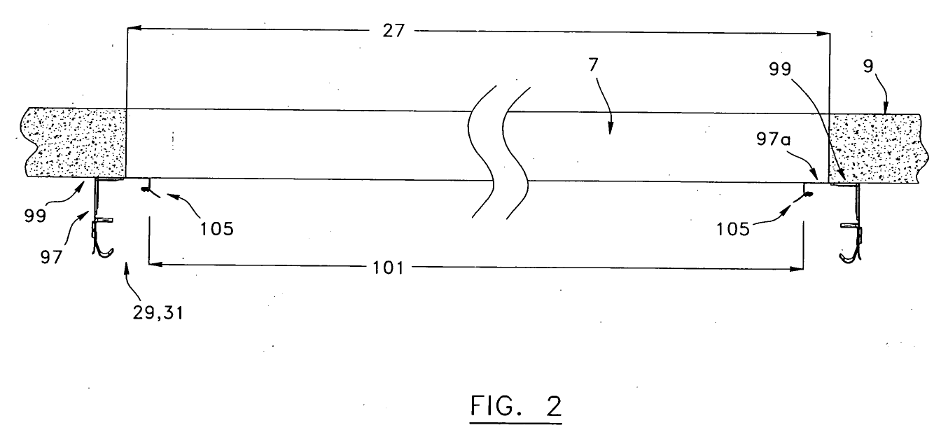

Preferably also, the second components 15 of the kit 1 comprise a pair of vertical angle sets 97 each being mountable onto opposite peripheral side edges 99 of an inside portion of the fixed structure 9 of the specific door opening 7, the vertical angle sets 97 being mountable with respect to each other in order to adjustably define a daylight width 101 within the specific door opening 7, said daylight width 101 being adjusted in accordance with the specific door leaf 13 to be used with the specific door assembly 23 to be assembled with the kit 1, as can be easily understood by a person skilled in the art when referring to FIGS. 1 and 2.

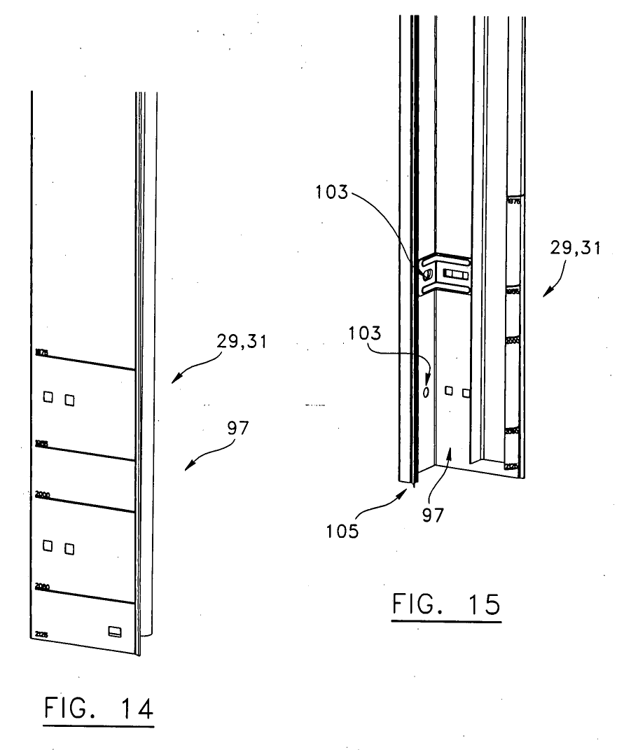

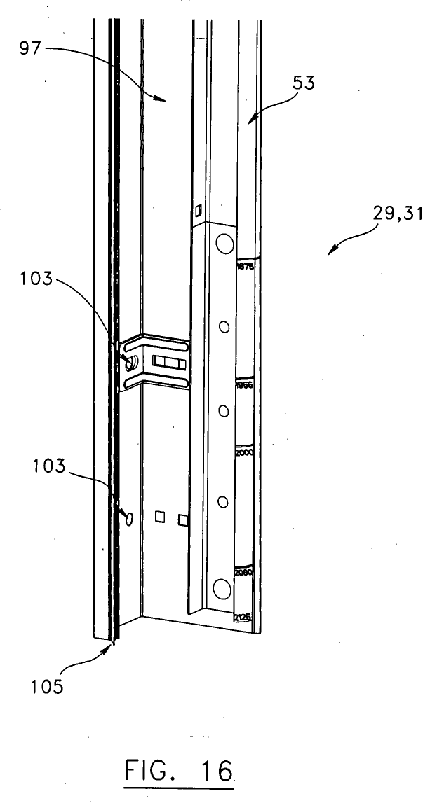

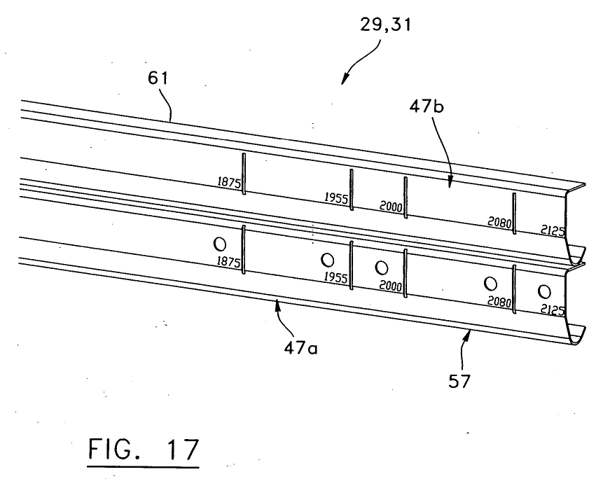

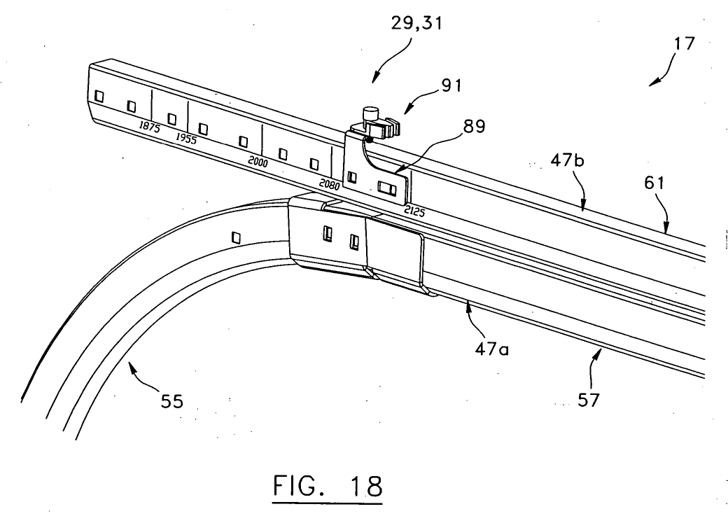

As better shown in FIGS. 14 and 15, each vertical angle set 97 is preferably provided with a corresponding set of holes 103 for receiving corresponding fasteners in order to be mounted onto a corresponding peripheral side edge 99 of the inside portion of the fixed structure 9 of the specific door opening 7. Each vertical angle set 97 is substantially L-shaped, as better shown in FIG. 2.

Referring back to FIGS. 14-16, each vertical angle set 97 preferably comprises a marking system 31 with given increments, each vertical angle set 97 being adjustable along one of said increments according to the specific door assembly 23 to be assembled with the kit 1 for the specific door opening 7. The marking system 31 of each vertical angle set 97 comprises lines along which the vertical angle set 97 may be cut, said lines corresponding to different possible door configurations of the kit 1. Each vertical angle set 97 is provided with a side sealing 105 having an overlap cooperable with the specific door leaf 13, as better shown in FIG. 2.

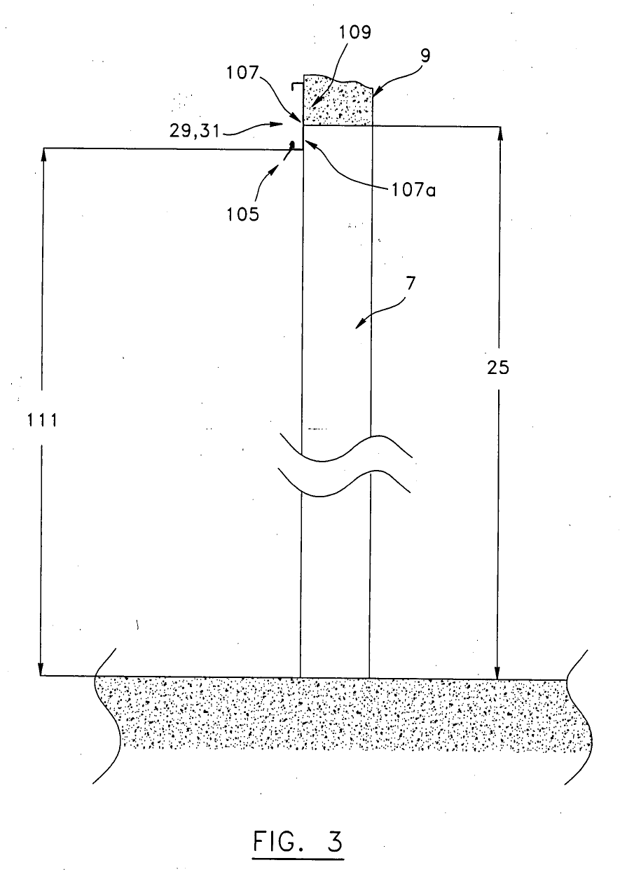

Preferably also, and as better shown in FIG. 3, the second components of the kit 1 comprise a cosmetic lintel 107 mountable onto a peripheral upper edge 109 of an inside portion of the fixed structure 9 of the specific door opening 7, the cosmetic lintel 107 being mountable with respect to a ground surface of the specific door opening 7 in order to adjustably define a daylight height 111 within said specific door opening 7, said daylight height 111 being adjusted in accordance with the specific door leaf 13 to be used with the specific door assembly 23 to be assembled with the kit 1.

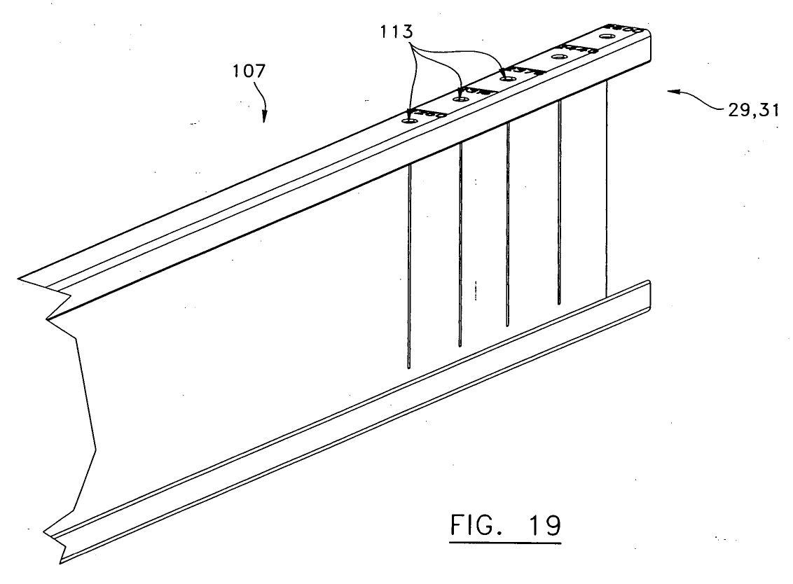

As better shown in FIG. 19, the cosmetic lintel 107 is preferably provided with a corresponding set of holes 113 for receiving corresponding fasteners in order to be mounted onto the corresponding peripheral upper edge 109 of the inside portion of the fixed structure 9 of the specific door opening 7.

Preferably also, and as shown in FIG. 19, the cosmetic lintel 107 comprises a marking system 31 with given increments, the cosmetic lintel 107 being adjustable along one of said increments according to the specific door assembly 23 to be assembled with the kit 1 for the specific door opening 7. The marking system 31 of the cosmetic lintel 107 comprises lines along which the cosmetic lintel 107 may be cut, said lines corresponding to different possible door configurations of the kit 1.

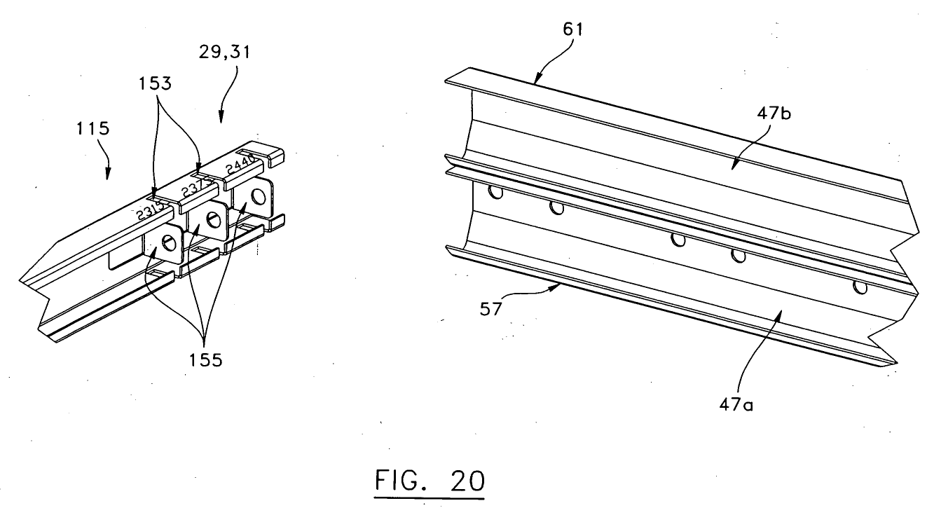

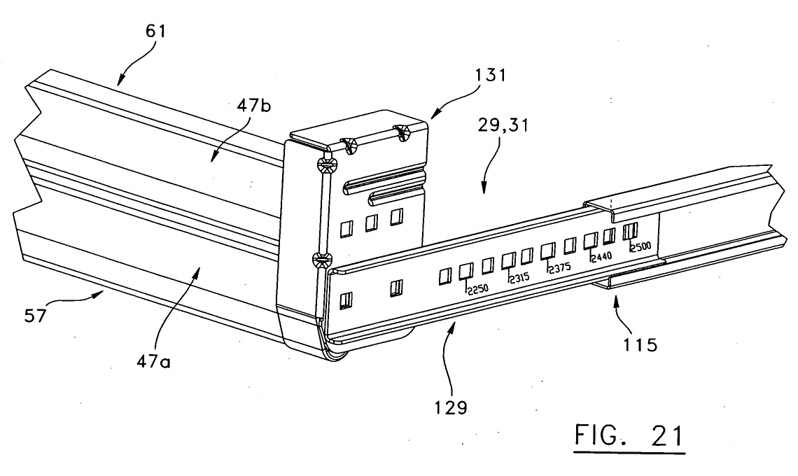

The second components 15 of the kit 1 also preferably comprise a distance beam 115 being removably connectable between a pair of lateral tracks 47 of the track system 17. As better shown in FIGS. 20 and 21, the distance beam 115 is preferably provided with a marking system 31 (which may be varied) with given increments, the distance beam 115 being adjustable along one of said increments according to the specific door assembly 23 to be assembled with the kit 1 for the specific door opening 7.

Preferably, sectional panels 37 of the specific door leaf 13 comprise an anti-pinch design between adjacent sectional panels 37. The first components 11 also preferably comprise top and bottom profiles 117,119 removably mountable onto top and bottom edges of sectional panels 37 for varying the effective height dimensions of said sectional panels 37 in order to adjustably form the specific door leaf 13 depending on the dimensions of the specific door opening 7, as better shown in FIGS. 1 and 2.

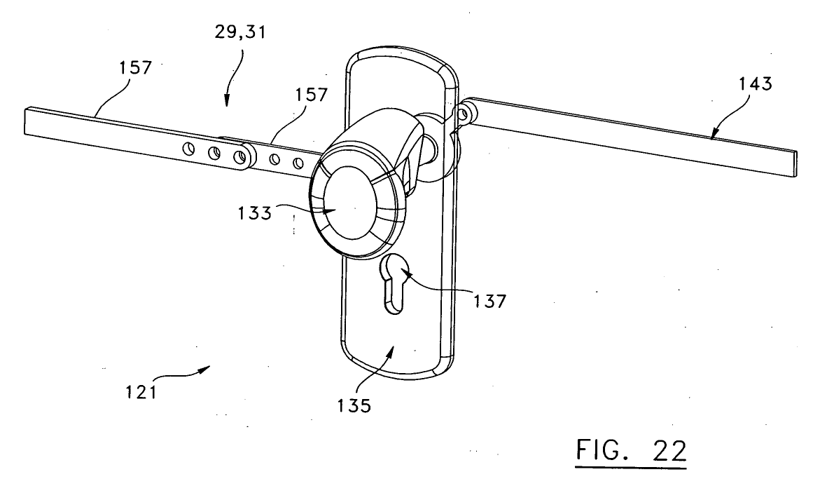

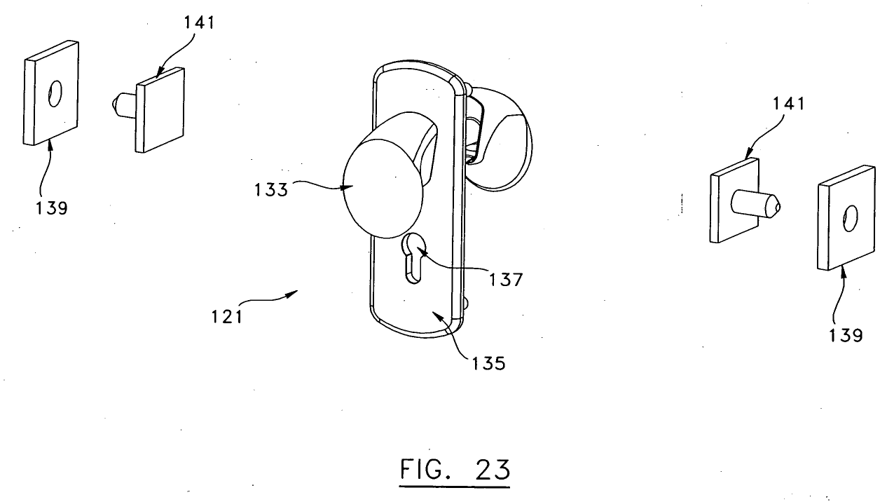

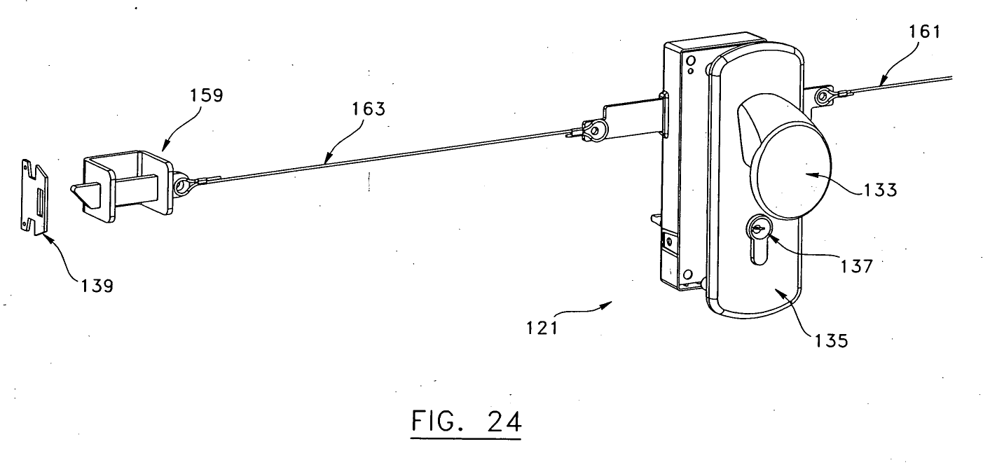

Preferably also, the first components 11 of the kit 1 also comprise a lock assembly 121 mountable onto the specific door leaf 13, the lock assembly 121 being operable between a locking mode where a component of the lock assembly 121 is engaged with the track system 17 so as to prevent the specific door leaf 13 from being opened with respect to said track system 17, and an unlocked mode where the component of the lock assembly 121 is disengaged from the track system 17 so as to allow the specific door leaf 13 to be opened and travel along said track system 17. Several different embodiments of lock assemblies 121 possible according to the present invention are exemplified in FIGS. 22-24.

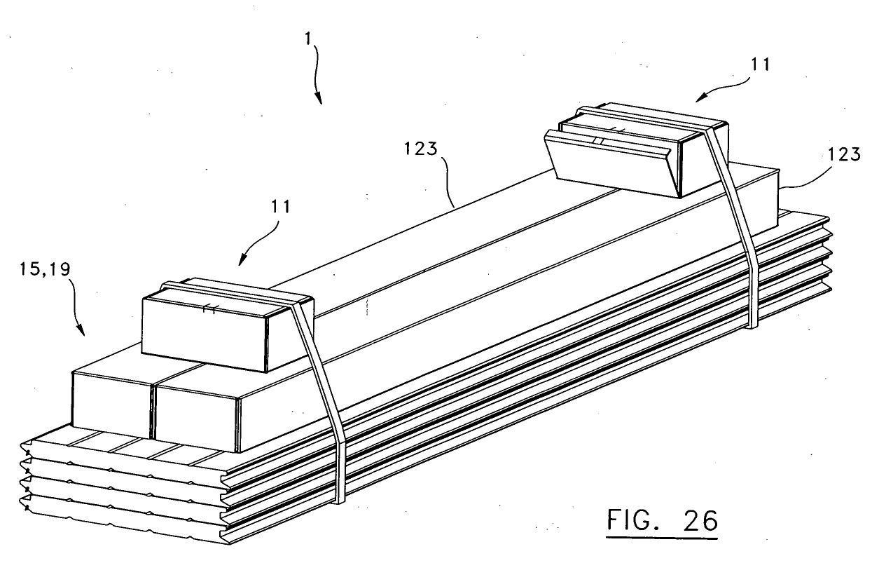

According to a preferred embodiment of the present invention, and as can be easily understood when referring to FIGS. 26-28, the second and third components 15,19 of the kit 1 are provided in a main shipping box 123 defining a recess 125, and the first components 11 of the kit 1 are provided in an auxiliary shipping box 127 shaped and sized to be nested into the recess 125 of the main shipping box 123.

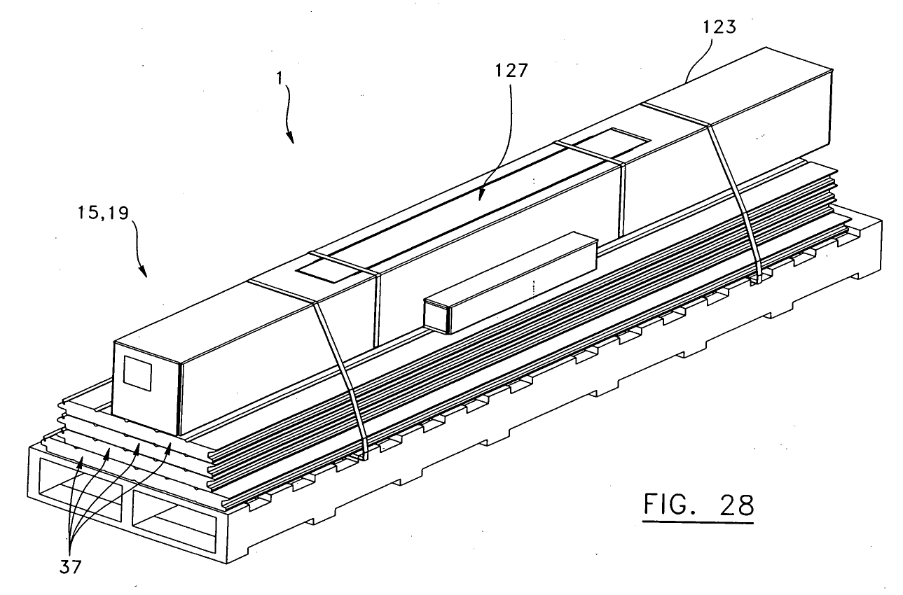

Preferably also, the kit 1 further comprises sectional panels 37 provided with the main and auxiliary shipping boxes 123,125, said sectional panels 37 being intended to form the specific door leaf 13 with the first components 11 of the kit 1. The main and auxiliary shipping boxes 123,127 are strapped together, wherein the sectional panels 37 are pilled one onto another, and the main shipping box 123 and the sectional panels 37 are strapped together, the auxiliary shipping box 127 being nested into the recess 125 of the main shipping box 123, and the main shipping box 123 being placed on top of the sectional panels 37, as better shown in FIG. 28.

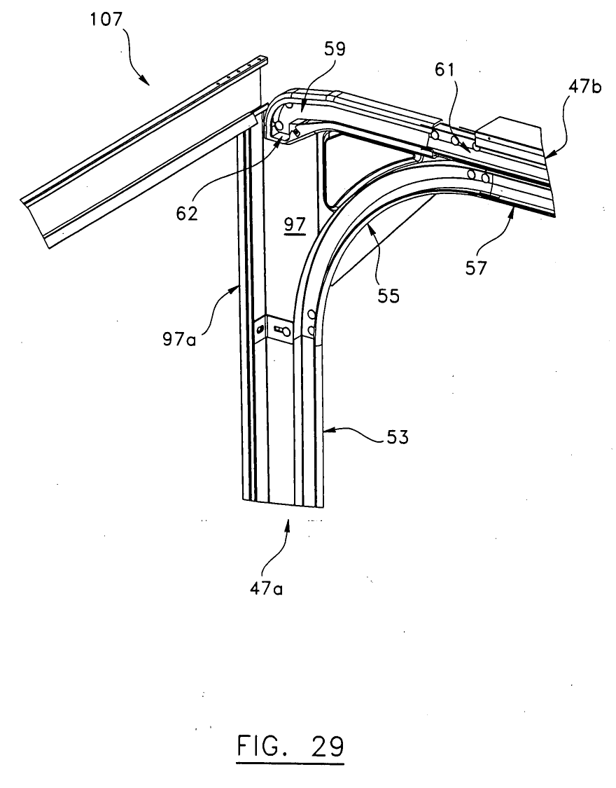

Thus, and as aforementioned, according to a first preferred embodiment, the present invention concerns an articulated overhead door comprising several panels 37 linked together one after another in the direction of motion. The panels 37 are guided by rollers 39 at each end traveling in two sets of lateral tracks 47. The first set of tracks 47a has a more or less vertical section 53 that merges into a curved section 55 and then into a horizontal section 57. The second set of tracks 47b has a horizontal section 61 that merges into a downward-sloping transitional section 59 and then, next to the doorway, into a vertical section 62, as better shown in FIG. 29. The horizontal section 61 of the second set of tracks 47b is positioned just over and paralleling the horizontal section 57 of the first set of tracks 47a. The panel 37 that is uppermost when the door is closed is guided by rollers 39a at the upper edge. These rollers 39a travel in the second set of tracks 47b. The door is preferably balanced by a mechanism comprising more or less horizontal helical tension springs 73 or vertical helical tension springs 73, deflection rollers, and cables. One end of each spring 73 is secured to a housing 81 which is secured to either the first or second set of tracks 47. The other end of each spring 73, the end extending into the doorway or the end extending to the ceiling, is fastened to a deflection pulley 95. Preferably, each cable 27 is fixed at one end, wraps around a pulley 95, and extends to a point established at one end of the bottom edge of the panel 37 that is lowermost when the door is closed, as can be easily understood by a person skilled in the art.

Referring more specifically to FIG. 1, there is shown a general view of the invention in its assembled state, according to a preferred embodiment of the present invention. The invention preferably consists of a sectional overhead door having a helical tension spring system to balance the door leaf 13 in any position, built and packaged in a way that one set of components fits all doors in the predefined range. This predefined range of dimensions for a daylight opening preferably goes from about 1875 mm to about 2125 mm in height, and from about 2125 mm to about 2500 mm in width. The daylight opening dimensions are the real maximum dimensions through the opening of the sectional overhead door, regardless of the garage opening before the installation (the daylight width 101 can be seen on FIG. 2 while the daylight height 111 can be seen on FIG. 3). This range covers each and every millimeter in-between said limits. The sectional overhead door assembly 23 preferably has two vertical angle sets 97, one on each side of the door assembly 23. The door assembly 23 preferably also has a cosmetic lintel 107 that allows an infinite adjustment regarding the door leaf height in-between said defined discreet adjustments. The door assembly 23 preferably also has a track system made of two sets of tracks 47a, a vertical section 53 and a horizontal section 57, and a track bend 55, on each side of the door assembly 23. The track system allows the door leaf 13 to be guided in its movement from the totally closed position to the totally opened position. The door assembly 23 preferably also has a distance beam 115 that ensures a fixed position in-between the track sets 47 disposed on each side of the door. The door assembly 23 preferably also has a door leaf 13 made of a plurality of interconnected panels 37 held together by adjustable hinges 35 and intermediate hinges 33. Preferably also, the door leaf 13 has panels 37 which feature an anti-pinch design. The door leaf 13 is balanced by a set of spring boxes 71 that are connected to the bottom of the door leaf 13 by a cable assembly made of at least two cables 67, one on each side of the door. The door leaf 13 preferably has at least one roller 39 on each vertical edge that are used for guiding the door leaf panels in the track system 17. The door assembly 23 preferably also has a lock assembly 121 which is located on the door leaf 13 and that is capable of locking at least on one side, but preferably both sides of the door leaf 13.

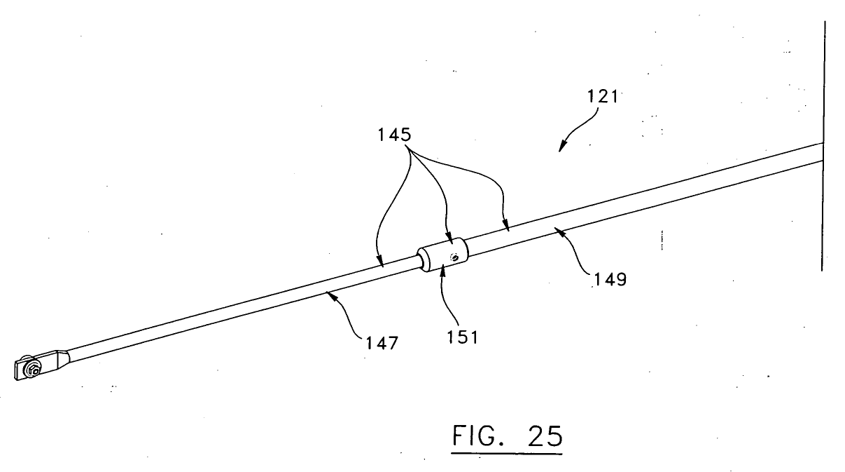

Following is a detailed description of preferred embodiments of the present invention with references to FIGS. 1 to 29. Indeed, the door leaf 13 is made in a way that its width can be adjusted by the door system builder as long as by the panel manufacturer. This is done for example by having specific end caps 43 for each door leaf panel brands and models. The removable end caps 43 preferably have holes 45 to ease the installation process. The end caps 43 are preferably added to protect the inside of the door leaf panels 37 and to allow rigid attachment of the hinges 33, 35 and brackets 49, 51, as can be easily understood by a person skilled in the art.

Preferably also, the door leaf panels 37 are made in a way that their height can be adjusted by the door system builder as long as by the panel manufacturer. This is done for example by having specific top and bottom profiles 117, 119 for each door leaf panel brands and models. The top profile 117 is meant to protect the inside of the door leaf panels 37 while the bottom profile 119 is meant to have a levelled interface with the ground, as can be easily understood by a person skilled in the art.

Preferably also, the door leaf panels 37 are also made in a way that the junction in-between each said panels 37 has an anti-pinch design as it can be seen on FIG. 5. The anti-pinch designs vary between panel brands and models. The anti-pinch designs are already known in the art and are thus not discussed in the context of the present description.

Preferably also, the door leaf top panel 37 has two top corner brackets 51, one on each side of the door leaf 13. The top corner brackets 51 are used for holding rollers 39a that are dedicated to the horizontal track set 47b as is briefly explained below, and as can be easily understood by a person skilled in the art.

Preferably also, the door leaf bottom panel 37 has two bottom corner brackets 53, one on each side of the door leaf 13. The bottom corner brackets 53 are used for holding rollers 39b that are guided in both vertical section 53 and horizontal section 57 and in the track bend 55. The bottom corner brackets 53 do not need to be adjustable in the present embodiment.

Preferably also, the door leaf 13 has several rollers 39 on both sides of the garage opening to allow the door leaf panels 37 to be guided in the track system 17. The rollers 39 are preferably made of a shaft 63 and a head 65 which is rotating around an axis of said shaft 63. Each roller head 65 preferably has a frictionless surface over the shaft 63 so it can turn freely.

Preferably also, the cable assembly is made of at least one cable 67 which length is the same for every dimension in the said range. The cable 67 is attached at one end on the bottom edge of the bottom panel 37 of the door leaf 13 while the other end is passing through a pulley 95 and then attached to the horizontal track assembly through the cable attachment bracket 89 as it can be seen on FIG. 18. The length of the cable 67 is manufactured so it is long enough for a door leaf 13 having the maximum height dimension in the predetermined range. The position of the cable 67 is then determined by the position of the cable attachment bracket 89 which is aligned on the marking system 31.

Preferably also, the cable assembly is attached on the cable attachment bracket 89 by a rotating clip 91 that equilibrates the tension in both cables 67 of the cable assembly, as aforementioned.

Preferably also, the spring box 81 has means to adjust its tension by the rotation of a threaded shaft 83. The spring box 81 is then made of a displaceable bracket 75 which can move freely along the axis of the helical tension springs 73, only under the rotation of the said threaded shaft 83. The translation of the displaceable bracket 75 is possible because of a threaded portion mating the threaded shaft 83 and because of its blocked rotation upon the spring box case 81. The adjustment of the tension of the helical tension springs 73 is made by rotating the threaded shaft 83. The rotation of the threaded shaft 83 moves the displaceable bracket 75 along the axis of the said helical tension springs 73, thus stretching the helical tension springs 73. This way of adjusting the tension of the helical tension springs 73 enables tension adjustment for the predetermined range of door leaf 13, as can be easily understood by a person skilled in the art.

Preferably also, the spring box 81 has windows 85 that allow a person to see the position of the said displaceable bracket 75 while adjusting the tension of the said helical tension springs 73. A marking system 31 besides the windows 85 allow easy adjustment of the tension of the said helical tension springs 73 according the to said range of door leaf 13.

Preferably also, the adjustable hinges 35 are made of at least four members which are the top hinge 35a, the bottom hinge 35b, the pivot point 35c, and the roller holder 35d as can be seen on FIG. 4. The purpose of said adjustable hinges 35 is to allow the adjustment of the rollers 39 so that the distance between the axis of the rollers 39 and the door leaf 13 can be changed according to the different brands and models of the door leaf 13 and according to the height of the vertical angle set 97 and said vertical track set 53. The adjustment of the rollers 39 is made by moving the roller holder 35d on a plane parallel to the ground and perpendicular to the door leaf 13 when the door leaf 13 is in the fully closed position.

Preferably also, the vertical angle set 97 has a marking system 31 as can be seen in FIGS. 14-16. The marking system 31 is done so the installer is able to cut the vertical angle set 97 to a defined height that is related to the door leaf height in the range.

Preferably also, the vertical angle set 97 is built in a way that the real garage door opening dimensions width 27 can be different that of the daylight width 101. This is done in a way that the face 97a of the vertical angle set 97 has a surface finish that is similar to the door leaf panels 37 and in a way that the face 97a allows a visible width, when combined with said same face 97a of the second vertical angle set 97, that is larger or equal than the increment of door leaf width in the range.

Preferably also, the vertical track set 53 is built in a way so that there is a small angle between the axis of the vertical track set 53 and the wall of the garage opening 7. Thus small angle is needed to ensure proper movement and sealing of the door leaf 13 when it is completely closed to the ground, as can be easily understood by a person skilled in the art.

Preferably also, the vertical track set 53 has a marking system 31 as can be seen on FIG. 16. The marking system 31 is done so the installer is able to cut the vertical track set 53 to a defined height that is related to the door leaf height in the range.

Preferably also, the side sealing 105 located on the vertical angle set 97 has a large overlap over the door leaf 13 in order to compensate for the cutting of the removable section of said vertical angle set 97. Since the vertical track set 53 has a small angle, as aforementioned, the distance between the vertical track set 53 and the wall of the garage opening is not going to be constant for all door leaf height dimension in the range, as can be easily understood by a person skilled in the art.

Preferably also, the side sealing 105 is made of a specific material that is more resistant to hard rubbing. This resistance is needed because of the larger overlap over the door leaf 13 which will result in higher pressure of the side sealing on the door leaf 13.

Preferably also, the horizontal track set 47 is made of at least three members which are an upper horizontal track 47b, a lower horizontal track 47a and a down-sloping track section 59 with a small radius connected to the upper horizontal track 47b. The upper horizontal track 47b and the down-slopping track section 59 are used for containing the top rollers 39a on each side of the door leaf 13. The upper horizontal track set 47b allows smaller overhead space, as can be easily understood by a person skilled in the art.

Preferably also, the upper horizontal track set 47b is supplied so its length is longer than the tallest door leaf 13 of the predetermined range of the kit 1. This allows the spring box 71 and the cable assembly to be the same for all door leaf dimensions in the range.

Preferably also, the cosmetic lintel 107 has a marking system 31 as it can be seen on FIG. 19. The marking system 31 is done so the installer is able to cut the cosmetic lintel 107 to defined widths that are related to the door leaf width in the range.

Preferably also, the cosmetic lintel 107 has a series of holes 113 located on a plane perpendicular to the wall of the garage opening. The holes 113 are located in a way that it is possible to fix the cosmetic lintel 107 to the vertical angle set 97 and to the track system even if cutting is needed.

Preferably also, the cosmetic lintel 107 is built in a way that the real garage door opening dimensions in height 25 can be different than the daylight height 111. This is done in a way that the face 107a of the cosmetic lintel 107 has a surface finish that is similar to the door leaf panels and in a way that the face 107a allows a visible height that is larger or equal than the increment of door leaf height in the range.

Preferably also, the distance beam 115 is connected to the horizontal track assembly through the distance beam connection bracket 129 on the end bracket 131. The distance beam connection bracket 129 preferably has a plurality of holes that matches the specified daylight width (DLW) in the range. The distance beam 115 is then fastened to the said connection bracket 129 using the marking system 31 indicating the DLW of the door leaf 13. The distance beam 115 is connected to both horizontal track sets 47 on each side of the door so the distance in-between the rear (farthest to the garage entrance) of the assemblies is identical to the distance in-between the front (closer to garage entrance) of the track sets 47.

Preferably also, the lock assembly 121 comprises several members which are at least a handle 133, a housing 135, a cylinder lock 137, a catcher 139, a lock pawl 141, a short rigid member 143, and an optional telescopic rigid members 145. The lock assembly 121 is a single-acting or double-acting lock in a way that it locks one or both sides of the door leaf 13 to ensure proper locking condition of the door assembly 23. The lock assembly 121 is adjustable on the installation site by having a telescopic member 147 that goes within a housing member 149 and that is locked by a threaded fastener though several holes in the coupling 151, the housing member 149 and the telescopic member 147. This adjustment method allow on-site compatibility with the predetermined range of door leaf 13.

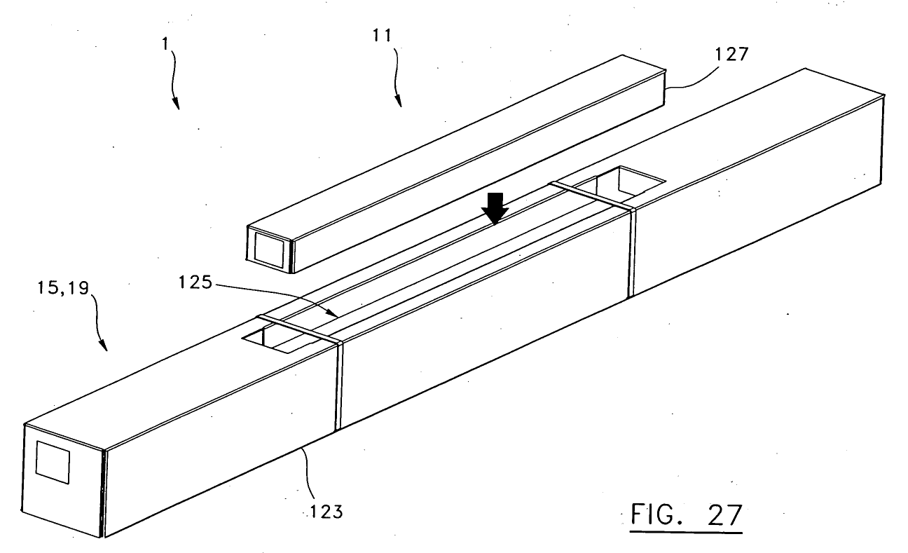

Preferably also, the packaging method of the hardware kit 1 according to a preferred embodiment of the present invention is made of an assembly of two boxes as it can be seen on FIG. 27. The bigger box 123 preferably contains all parts except those related to specific door leaf brands. This box 123 preferably has a recess 125 preferably on top to accept the smaller box 127. Both boxes 123,127 are preferably wrapped in a plastic foil that is water, dust and wind resistant. The bigger box 123 plastic foil is made in a way that the smaller box 127 can be inserted in the bigger box recess 125 without the need to remove or modify the plastic foil of both boxes 123,127.

Preferably also, the smaller box 127 can be permuted with the correct door leaf brand hardware in a fast and economical way without having to replace the protection to the package.

Preferably also, the packaging method of the whole door assembly 23 according to a preferred embodiment of the present invention is made of an assembly of several packages as better shown on FIG. 28. The packaging method of the whole door assembly 23 is made of at least a hardware kit, a manual or electric operator/lock and door leaf panels 37. This packaging method allow the system builder to customize every door in a fast and economical way.

In this preferred embodiment, the door assembly 23 is manually operated. The present invention is also meant to be compatible with electric motor operation as well as manual operation.

It is worth mentioning that several modifications could be made to the present door kit 1, as briefly explained herein, and as exemplified in the accompanying drawings, without departing from the scope of the present invention, as apparent to a person skilled in the art, examples of which are briefly mentioned hereinbelow.

For example, the range of dimensions for a door daylight width 101 could be from about 1000 mm to about 5000 mm, and those of a door daylight height 111 from about 1000 mm to about 3000 mm.

Preferably also, the door leaf panels 37 are made in a way that the means to adjust height and width are made available to the installer. The end caps 43 are preferably built in a way that they are removable by a skilled and trained installer. This feature will allow installer to cut the width of the panels 37 as it can be seen on FIG. 6. The end caps 43 are removable but also built in a way that it is possible to install them back to the door leaf panels 37. The top and bottom profiles 117,119 are built in a way that they are removable by a skilled and trained installer. This feature will allow installer to cut the height of the top and bottom panels 37. The top and bottom profiles 117,119 are removable, but also built in a way that it is possible to install them back on the door leaf panels 37. The door leaf panels 37 preferably have a removable and protective marking system, such as a plastic covering, to allow easy cutting by the installer with enough protection to prevent permanent rubbing or scratching.

Preferably also, the door leaf top panel 37 has two top corner brackets 49, one on each side of the door leaf 13. The top corner brackets 49 are used for holding rollers 39 that are intended for the horizontal track set 47 as explained above. The top corner brackets 49 are adjustable on a plane parallel to the door leaf 13 along a vertical line. Alternatively, the top corner brackets 49 may be adjustable on a plane parallel to the door leaf 13 along a vertical line and preferably also, the roller holders are adjustable on a plane parallel to the ground and perpendicular to the door leaf 13. The top corner brackets 49 may also be adjustable on a plane parallel to the door leaf (6) along a vertical line, and the roller holders can also be adjustable on a plane perpendicular to the ground and perpendicular to the door leaf 13.

Preferably also, the door leaf bottom panel 37 has two bottom corner brackets 51, one on each side of the door leaf 13. The bottom corner brackets 51 are holding rollers 39 that are guided in both vertical track set 53 and horizontal track set 57 and in the track bend 55. The bottom corner brackets 51 are made of at least two members which are the bracket and the roller holder. The bottom corner brackets 51 are adjustable on a plane parallel to the door leaf 13 along a vertical line and the roller holders are adjustable on a plane parallel to the ground and perpendicular to the door leaf 13. The bottom corner brackets 51 may be also adjustable on a plane parallel to the door leaf 13 along a vertical line, and the roller holders are adjustable on a plane perpendicular to the ground and perpendicular to the door leaf 13.

Preferably also, the door leaf 13 has several rollers 39 on both side of the garage opening to allow the door leaf panels 37 to be guided in a track system 17. The rollers 39 are made of a shaft 63 and a head 65 which is rotating around the axis of the shaft 63. Preferably also, the roller head 65 has a ball bearing around said shaft 63 so it can turn freely.

Preferably also, the cable assembly is made of at least one cable 67 whose length is the same for every dimension in the range. The cable 67 is attached at one end on the bottom edge of the bottom panel 37 of the door leaf 13 while the other end is passing through a pulley 95 and then attached to the structure 81 of the spring box 71 as it can be seen on FIG. 7. The length of each cable 67 is preferably manufactured so it is long enough for a door leaf 13 having the maximum height dimension in the predetermined range. The position of each cable 67 is then determined by the position of the spring box 71 which is installed at the edge of the horizontal track set 47 that is located at the farthest point relative to the garage opening, as can be easily understood by a person skilled in the art.

Preferably also, and as aforementioned, the cable assembly may have a one-way locking sleeve 69 at one end of the cable instead of a standard locking means. The one-way locking sleeve 69 allows easy adjustment of the cable by allowing the cable 67 to move freely in one direction while preventing its movement in the other direction. The one-way locking sleeve 69 is not a permanent lock as it can be unlocked to let the cable 67 get to its original position. The cable assembly has as many one-way locking sleeves 69 as there are cables 67 to allow an infinite adjustment of the cable lengths.

Preferably also, the cable assembly has one-way locking sleeves 69 and a marking system on the spring box 71 to allow a precise adjustment of the cable assembly length. This marking system is preferably built in a way that it is visible from all angles while adjusting the others, as can be easily understood by a person skilled in the art.

Preferably also, the marking system of the cable assembly has an identification means to allow the cables 67 on each side of the door to be adjusted of the same length. The marking system visible on the spring box 71 has identical and/or similar identification symbols on each side of the door so it is easily recognizable.

Preferably also, the cable assembly has a rotating device 93 to allow each said cables 67 of the cable assembly on each side of the door to be adjusted in length. The rotation device 93 is installed on each side of the door leaf 13 in each spring box 71 to adjust the length of the cables 67.

Preferably also, the cable assembly has a rotating device 93 to allow each corresponding cable 61 of the cable assembly on each side of the door to be adjusted in length. The rotation device 93 is installed on each side of the door leaf 13 on each vertical angle set 97 to adjust the length of the cables 67.

Preferably also, the spring box 71 comprises at least two helical tension springs 73 which are connected at one end on a anchor bracket 79 and at the other end to the pulley 77 as can it be seen in FIGS. 7-13. The tension of the spring box 71 can be adjusted by moving the anchor bracket 79 along the axis of the helical tension springs 73 to defined locations on the spring box housing 81. Each defined locations are related to specific door leaf dimensions in the range. The anchor bracket 79 can be fixed to the spring box housing 81 by means of a fastener, or other suitable means, as can be easily understood by a person skilled in the art.

Preferably also, the spring box 71 has means to adjust its tension by the rotation of a threaded shaft 83 and by the movement of displaceable bracket 75. The spring box 71 is then made of at least one threaded shaft 83 linked to an anchor bracket 79 which can move freely along the axis of the helical tension springs 73. The spring box 71 is also made of at least one displaceable bracket 75 having a threaded hole to let the threaded shaft 83 through. The displaceable bracket 75 is attached to the spring box housing 81 in regularly spaced slots or windows 85 that allow great tension adjustment to compensate for the range of door leaf dimensions. The spring box 71 is also made of a least one threaded cylinder having one surface mating the surface of the displaceable bracket 75. The adjustment of the tension of the helical tension springs 73 is made by rotating the threaded shaft 83. The rotation of the threaded shaft 83 moves the displaceable bracket 75 along the axis of the helical tension springs 73, thus stretching said helical tension springs 73. This way of adjusting the tension of the helical tension springs 73 allows minor tension adjustment and major tension adjustment, as can be easily understood by a person skilled in the art.

Preferably also, the adjustable hinges 35 are made of at least four members which are the top hinge 35a, the bottom hinge 35b, the pivot point 35c, and the roller holder 35d. The purpose of the adjustable hinges 35 is to allow the adjustment of the rollers 39 so the distance between the axis of the rollers 39 and the door leaf 13 can be changed according to the different brands and models of the door leaf 13 and according to the height of the vertical angle set 97 and vertical track set 53. The adjustment of the rollers 39 is made by moving the roller holder 35d on a plane perpendicular to the ground and perpendicular to the door leaf 13 when the door leaf 13 is in the fully closed position, as can be easily understood by a person skilled in the art.

Preferably also, the vertical track set 53 has a removable section that can be seen on FIG. 16. The removable section is connected to the vertical angle set 97 by fasteners having a thin head to allow the free movement of the door leaf 13 in the vertical track sets 53. The removable section also has a marking system 31 that allows the installer to cut it to a defined height according to the door leaf height in the predetermined range.

Preferably also, the vertical track set 53 may have a telescopic section. The telescopic section is connected to the vertical angle set 97 by fasteners having a thin head to allow the free movement of the door leaf 13 in the vertical track sets 53. The telescopic section also preferably has a marking system that allows the installer to adjust the telescopic section to defined heights according to the door leaf height in the predetermined range.

Preferably also, the vertical angle set 97 has a marking system (31) as it can be seen on FIG. 16. Such marking system 31 is done so the installer is able to cut the vertical angle set 97 to defined height that is related to the door leaf height in the predetermined range. The vertical angle set 97 also preferably has a bottom cap whose function is to cover the cut portion of the vertical angle set 97 which is otherwise visible to the end user.

Preferably also, the horizontal track set 47 is supplied so its length is longer than the tallest door leaf 13 of the predetermined range. The horizontal track set 47 also has a marking system 31 on the upper horizontal track 47b and the lower horizontal track 47a which allows the installer to properly install fixation members to the garage structure and to trim cut the exceeding portion of the upper horizontal track 47b and the lower horizontal track 47a. The marking system 31 allows to adjust the horizontal track set 47 to the door leaf height of the range.

Preferably also, the distance beam 115 is having a series of vertical slots 153 with a series of bent tabs 155 placed in-between each said vertical slots 153. The vertical slots 153 and the bent tabs 155 are placed at both ends of the distance beam 115 so that the distance in-between one vertical slot 153 on one end of the distance beam 115 is located at one of the specified distance in the range of door leaf 13 to another said located vertical slot 153 on the other end of the distance beam 115. The purpose of the vertical slot 153 is to allow the distance beam 115 to slide over the lower track 47a of the horizontal track set 47 so the bent tab 155 is locating the horizontal track set 47 on one side of the garage to a predefined distance to the horizontal track set 47 on the other side of the garage, as can be easily understood by a person skilled in the art.

Preferably also, the lock assembly 121 comprises several members which are at least a handle 133, a housing 135, a cylinder lock 137, a catcher 139, a lock pawl 141, a short rigid member 143, and at least two medium-size rigid members 157. The lock assembly 121 is a double-acting lock in a way that it locks on both sides of the door leaf 13 to ensure proper locking condition of the door assembly. The lock assembly 121 is adjustable on the installation site by having a series of holes in the medium-size rigid members 157. The holes on the medium-size rigid members 157 are made available so that multiple medium-size rigid members 157 can be assembled together with various alignment of the holes having as end results a variable length of the assembly of medium-size rigid members 157. The variable length of the assembly of the medium-size rigid members 157 is covering the different door leaf 13 width in the range, as can be easily understood by a person skilled in the art.

Preferably also, the lock assembly 121 is made of several members which are at least a handle 133, a housing 135, a cylinder lock 137, a latching mechanism 159 comprising a catcher 139 and a lock pawl 141, a short flexible member 161, and a long flexible member 163. The lock assembly 121 is a double-acting lock in a way that it locks on both sides of the door leaf 13 to ensure proper locking condition of the door assembly 23. The long flexible member 163 is supplied so it is long enough for the widest door leaf 13 of the predetermined range. The long flexible member 163 can be wrapped around a dedicated portion of the latching mechanism 159 so its length can be reduced to the different door leaf width of the predetermined range, as can be easily understood by a person skilled in the art.

Preferably also, the lock assembly 121 is made of several members which are at least a handle 133, a housing 135, a cylinder lock 137, a latching mechanism 159 comprising a catcher 139 and a lock pawl 141, a short flexible member 161, and a long flexible member 163. The lock assembly 121 is a double-acting lock in a way that it locks on both sides of the door leaf 13 to ensure proper locking condition of the door assembly 23. The long flexible member 163 is supplied so it is long enough for the widest door leaf 13 of the predetermined range. The long flexible member 163 can be adjusted in length by installing an end button to a desired location so its length can be reduced to the different door leaf width of the predetermined range, as can be easily understood by a person skilled in the art.

Preferably also, the packaging method according to a preferred embodiment of the present invention is made of at least one package as it can be seen on FIG. 26. The packages are made of at least one box, but preferably made of at least three boxes that contain all parts except the door leaf 13 itself. One of the packages is made of at least one box 127 having an easy to open and close interface that allows multiple opening-closing cycles. The box 127 preferably contains the appropriate hardware related to the door leaf 13 that may change from door leaf brands and models. The box 127 is then preferably opened by the system builder so its content can be permuted with the correct set of hardware, without the need to unwrap and then wrap again the whole package.

Preferably also, the above-described packaging method is made of a material that is resistant to severe weather conditions such as humidity, heat, cold and sun. The boxes 123,127 of the package preferably have a special surface treatment that replace any form of wrapping of the boxes or package. Also, the boxes 123,127 have an easy to open and close interface built in a way that there is no leaking because of said interface.

Moreover, according to the present invention, the door kit 1 and corresponding components are preferably made of substantially rigid materials, such as metallic materials (steel, etc.), hardened polymers, composite materials, and/or the like, whereas other components thereof according to the present invention, in order to achieve the resulting advantages briefly discussed herein, are preferably made of a suitably malleable and resilient material, such as a polymeric material (plastic, etc.), and/or the like, depending on the particular applications for which the door kit 1 and resulting specific door assembly 23 are intended for and the different parameters in cause (counterbalancing force in the spring, weight of the door, etc.), as apparent to a person skilled in the art.

As being now better appreciated, the present invention is an improvement and presents several advantages over other related devices and/or methods known in the prior art. Indeed, the present invention offers solutions to get a high level of standardization, or in other words, a single kit fits all dimensions currently used for overhead sectional door with helical tension springs. The present invention is also advantageous in that it satisfies the following critical aspects of a complete door assembly, namely: door leaf width and height adjustment; cable length adjustment; spring tension adjustment; hinges adjustment; vertical track set height adjustment; horizontal track set length adjustment; cosmetic lintel width adjustment; distance beam width adjustment; lock assembly adjustment; and/or packaging method.

Of course, numerous modifications could be made to the above-described embodiments without departing from the scope of the invention, as defined in the appended claims.

1. A kit (1) for assembling a variety of different door configurations adapted to be installed within a predetermined range of dimensions, onto a specific door opening (7) defined within a fixed structure (9) and contained within said predetermined range of dimensions, the kit (1) comprising:
first components (11) for assembling a specific door leaf (13) shaped and sized for substantially covering the specific door opening (7);
second components (15) for mounting onto the fixed structure (9) of the specific door opening (7), the second components (15) including components (15) for assembling a track system (17) along which the specific door leaf (13) is configured to travel; and
third components (19) for assembling a counterbalancing system (21) operatively connectable between the specific door leaf (13) and the fixed structure (9) for counterbalancing the specific door leaf (13) with respect to said fixed structure (9);
the components (11,15,19) of the kit (1) being configured to be selectively adjustable along given increments for assembling a specific door assembly (23) representative of dimensions (25,27) of the specific door opening (7), and the components (11,15,19) of the kit (1) being further configured to be provided with adjustment means (29), and corresponding marking systems (31) representative of given increments, for selectively adjusting parameters of the components (11,15,19) of the kit (1) in response to the specific door leaf (13) being used for assembling the specific door assembly (23).

2. A kit (1) according to claim 1, wherein the first components (11) comprise hinges (33,35) for interconnecting sectional panels (37) so as to form the specific door leaf (13) to be used for the specific door assembly (23).

3. A kit (1) according to claim 2, wherein the hinges (33,35) comprise intermediate and adjustable hinges (33,35), the adjustable hinges (35) being mountable adjacent to side edges of the specific door leaf (13) and having each an adjustable component for receiving a corresponding roller (39) configured for traveling along the track system (17).

4. A kit (1) according to claim 3, wherein the adjustable component of each adjustable hinge (35) is displaceable with respect to said adjustable hinge (35) in a direction substantially perpendicular to an inner surface (41) of the specific door leaf (13) when each adjustable hinge (35) is mounted onto said specific door leaf (13).

5. A kit (1) according to claim 3, wherein each adjustable hinge (35) comprises a top hinge (35a), a bottom hinge (35b) hingedly connected to the top hinge via a pivot point (35c), and a roller holder (35d) operatively connected to the pivot point (35c) for holding a roller (39), the roller holder (35d) being displaceable with respect to said pivot point (35c) for adjustably varying a distance between a pivot axis of the roller (39) and an inner surface (41) of the specific door leaf (13) depending on the specific door assembly (23) being assembled with the kit (1).

6. A kit (1) according to claim 3, wherein each adjustable hinge (35) is adjusted depending on a given angle of an upright portion of the track system (17).

7. A kit (1) according to claim 1, wherein the first components (11) comprise ends caps (43) removably mountable onto side edges of sectional panels (37) for varying the effective width dimensions of said sectional panels (37) in order to adjustably form the specific door leaf (13) depending on the dimensions of the specific door opening (7).

8. A kit (1) according to claim 7, wherein the ends caps (43) are provided with holes (45) for receiving corresponding fasteners so as to securely fasten the ends caps (43) onto the sectional panels (37).

9. A kit (1) according to claim 7, wherein hinges (35) of the kit (1) are securely mountable onto the end caps (43).

10. A kit (1) according to claim 1, wherein the first components (11) comprise rollers (39) operatively mountable onto side edges of the specific door leaf (13) for guiding said specific door leaf (13) along corresponding tracks (47) of the track system (17).

11. A kit (1) according to claim 1, wherein the first components (11) comprise top corner brackets (49) mountable onto upper corners of the specific door leaf (13) for receiving corresponding top rollers (39a) configured for traveling along the track system (17).

12. A kit (1) according to claim 1, wherein the first components (11) comprise bottom corner brackets (51) mountable onto lower corners of the specific door leaf (13) for receiving corresponding bottom rollers (39b) configured for traveling along the track system (17).

13. A kit (1) according to claim 1, wherein the track system (17) comprises a pair of main lateral tracks (17a) along which opposite side edges of the specific door leaf (13) are configured to travel via corresponding rollers (39).

14. A kit (1) according to claim 13, wherein each main lateral track (47a) comprises a vertical section (53), a curved section (55) and a horizontal section (57), said sections (53,55,57) being connectable to one another so as to define a continuous main lateral track (47a) along which the corresponding rollers (39) of the specific door leaf (13) are adapted to travel.

15. A kit (1) according to claim 1, wherein the track system (17) comprises a pair of complementary lateral tracks (47b) along which opposite and upper portions of side edges of the specific door leaf (13) are configured to travel via corresponding top rollers (39a).

16. A kit (1) according to claim 15, wherein each complementary lateral track (47b) comprises a transitional section (59) and a horizontal section (61), said sections (59,61) being connectable to one another so as to define a continuous complementary lateral track (47b) along which the corresponding top rollers (39a) of the specific door leaf (13) are adapted to travel.

17. A kit (1) according to claim 16, wherein each complementary lateral track (47b) is connectable on top of and in parallel to a corresponding main lateral track (47a) of the track system (17).

18. A kit (1) according to claim 3, wherein each roller (39) of the kit (1) comprises a shaft (63) mountable onto a corresponding bracket (35,49,51) of the specific door leaf (13), and a head (65) rotatably mounted about said shaft (63).

19. A kit (1) according to claim 1, wherein the counterbalancing system (21) comprises at least one cable (67) having a first extremity operatively connectable to a corresponding component of the specific door leaf (13) and a second extremity operatively connectable to a corresponding component of the track system (17).

20. A kit (1) according to claim 19, wherein the second extremity of the at least one cable (67) is removably securable onto said corresponding component of the track system (17) via a one-way locking sleeve (69).

21. A kit (1) according to claim 19, wherein a portion of the at least one cable (67) is cooperable with a spring box (71), said spring box (71) having a component being deformable and capable of storing potential energy via a corresponding deformation so as operatively counterbalance the specific door leaf (13).

22. A kit (1) according to claim 21, wherein the spring box (71) is removably mountable and adjustably displaceable along a corresponding track (47) of the track system (17) so as to adjustably vary an effective length of at least one cable (67).

23. A kit (1) according to claim 21, wherein the spring box (71) comprises at least one helical tension spring (73) having a first end provided with a displaceable bracket (75) and a second end provided with a pulley (77) cooperating with a portion of the at least one cable (67).

24. A kit (1) according to claim 21, wherein the spring box (71) comprises an anchor bracket (79) securely mounted onto a housing (81) of the spring box (71), said anchor bracket (79) having a hole for receiving therethrough a corresponding threaded shaft (83), said threaded shaft (83) being threadedly engaged with either one of the brackets (75,79) and configured with the anchor bracket (79) such that a rotation of the threaded shaft (83) causes the displaceable bracket (75) to be displaced with respect to the anchor bracket (79), thereby adjusting the effective length of the at least one helical tension spring (73) and in turn adjusting the corresponding tension in the at least one cable (67).

25. A kit (1) according to claim 24, wherein the housing (81) of the spring box (71) comprises a marking system (31) with given increments each being representative of a given tension to be used for counterbalancing the specific door leaf (13) of the specific door assembly (23) to be assembled with the kit.

26. A kit (1) according to claim 25, wherein the marking system (31) of the spring box (71) comprises a series of windows (85) corresponding to given increments of tension, the displaceable bracket (75) being positionable along one of said windows (85) so as to vary the effective length of the at least one helical tension spring (73) and in turn adjust the corresponding tension in the at least one cable (67) for the specific door leaf (13) to be used with the specific door assembly (23) to be assembled with the kit (1).

27. A kit (1) according to claim 26, wherein the displaceable bracket (75) is provided with a clip (87) removably insertable into the windows (85) of the marking system (31) of the spring box (71).

28. A kit (1) according to claim 23, wherein said at least one helical tension spring (73) comprises a pair of helical tension springs (73) for each spring box (71).

29. A kit (1) according to claim 19, wherein the second extremity of the at least one cable (67) is connected to a corresponding component of the track system (17), said corresponding component of the track system (17) comprising a marking system (31) with given increments, said corresponding component of the track system (17) being removably mountable onto one of said increments so as to provide a specific effective length in the at least one cable (67) of the counterbalancing system (21) in response to the specific door leaf (13) to be used with the specific door assembly (23) to be assembled with the kit (1).

30. A kit (1) according to claim 29, wherein the corresponding component of the track system (17) comprises a cable attachment bracket (89) removably mountable onto a corresponding track (47) of the track system (17).

31. A kit (1) according to claim 30, wherein the cable attachment bracket (89) is provided with a rotating clip (91) for receiving the second extremity of the at least one cable (67).

32. A kit (1) according to claim 31, wherein the corresponding component of the track system (17) comprises a rotating device (93) removably mountable onto a corresponding track (47) of the track system (17), the second extremity of the at least one cable (67) being connected to said rotating device (93) and a portion of said at least one cable (67) being woundable about the rotating device (93) for adjustably varying the tension to be used for counterbalancing the specific door leaf (13) of the specific door assembly (23) to be assembled with the kit (1).

33. A kit (1) according to claim 32, wherein the rotating device (93) comprises a marking system (31) with given increments each being representative of a given tension to be used for counterbalancing the specific door leaf (13) of the specific door assembly (23) to be assembled with the kit (1).

34. A kit (1) according to claim 19, wherein the third components comprise at least one pulley (95) mountable onto a corresponding section of the track system (17) and cooperable with a portion of the at least one cable (67).

35. A kit (1) according to claim 19, wherein the at least one cable (67) comprises a cable length dimensioned so as to cover all the different door configurations possible with the kit (1).

36. A kit according to claim 19, wherein the kit (1) comprises a pair of said at least one cables (67), each cable (67) being used for counterbalancing a corresponding side of the specific door leaf (13).

37. A kit (1) according to claim 1, wherein the predetermined range of dimensions comprises a height dimension ranging from about 1000 mm to about 3000 mm, and a width dimension ranging from about 1000 mm to about 5000 mm.

38. A kit (1) according to claim 1, wherein the predetermined range of dimensions comprises a height dimension ranging from about 1875 mm to about 2125 mm, and a width dimension ranging from about 2125 to about 2500 mm.

39. A kit (1) according to claim 1, wherein the second components (15) comprise a pair of vertical angle sets (97) each being mountable onto opposite peripheral side edges (99) of an inside portion of the fixed structure (9) of the specific door opening (7), the vertical angle sets (97) being mountable with respect to each other in order to adjustably define a daylight width (101) within the specific door opening (7), said daylight width (101) being adjusted in accordance with the specific door leaf (13) to be used with the specific door assembly (23) to be assembled with the kit (1).

40. A kit (1) according to claim 39, wherein each vertical angle set (97) is provided with a corresponding set of holes (103) for receiving corresponding fasteners in order to be mounted onto a corresponding peripheral side edge (99) of the inside portion of the fixed structure (9) of the specific door opening (7).

41. A kit (1) according to claim 39, wherein each vertical angle set (97) is substantially L-shaped.

42. A kit (1) according to claim 39, wherein each vertical angle set (97) comprises a marking system (31) with given increments, each vertical angle set (97) being adjustable along one of said increments according to the specific door assembly (23) to be assembled with the kit (1) for the specific door opening (7).

43. A kit (1) according to claim 42, wherein the marking system (31) of each vertical angle set (97) comprises lines along which the vertical angle set (97) may be cut, said lines corresponding to different possible door configurations of the kit (1).

44. A kit (1) according to claim 39, wherein each vertical angle set (97) is provided with a side sealing (105) having an overlap cooperable with the specific door leaf (13).

45. A kit (1) according to claim 1, wherein the second components comprise a cosmetic lintel (107) mountable onto a peripheral upper edge (109) of an inside portion of the fixed structure (9) of the specific door opening (7), the cosmetic lintel (107) being mountable with respect to a ground surface of the specific door opening (7) in order to adjustably define a daylight height (111) within said specific door opening (7), said daylight height (111) being adjusted in accordance with the specific door leaf (13) to be used with the specific door assembly (23) to be assembled with the kit (1).

46. A kit (1) according to claim 45, wherein the cosmetic lintel (107) is provided with a corresponding set of holes (113) for receiving corresponding fasteners in order to be mounted onto the corresponding peripheral upper edge (109) of the inside portion of the fixed structure (9) of the specific door opening (7).

47. A kit (1) according to claim 45, wherein the cosmetic lintel (107) comprises a marking system (31) with given increments, the cosmetic lintel (107) being adjustable along one of said increments according to the specific door assembly (23) to be assembled with the kit (1) for the specific door opening (7).

48. A kit (1) according to claim 47, wherein the marking system (31) of the cosmetic lintel (107) comprises lines along which the cosmetic lintel (107) may be cut, said lines corresponding to different possible door configurations of the kit (1).

49. A kit (1) according to claim 1, wherein the second components (15) comprise a distance beam (115) being removably connectable between a pair of lateral tracks (47) of the track system (17).

50. A kit (1) according to claim 49, wherein the distance beam (115) is provided with a marking system (31) with given increments, the distance beam (115) being adjustable along one of said increments according to the specific door assembly (23) to be assembled with the kit (1) for the specific door opening (7).

51. A kit (1) according to claim 1, wherein sectional panels (37) of the specific door leaf (13) comprise an anti-pinch design between adjacent sectional panels (37).

52. A kit (1) according to claim 1, wherein the first components (11) comprise top and bottom profiles (117,119) removably mountable onto top and bottom edges of sectional panels (37) for varying the effective height dimensions of said sectional panels (37) in order to adjustably form the specific door leaf (13) depending on the dimensions of the specific door opening (7).

53. A kit (1) according to claim 1, wherein the first components (11) comprise a lock assembly (121) mountable onto the specific door leaf (13), the lock assembly (121) being operable between a locking mode where a component of the lock assembly (121) is engaged with the track system (17) so as to prevent the specific door leaf (13) from being opened with respect to said track system (17), and an unlocked mode where the component of the lock assembly (121) is disengaged from the track system (17) so as to allow the specific door leaf (13) to be opened and travel along said track system (17).

54. A kit (1) according to claim 1, wherein the second and third components (15,19) of the kit (1) are provided in a main shipping box (123) defining a recess (125), and wherein the first components (11) of the kit (1) are provided in an auxiliary shipping box (127) shaped and sized to be nested into the recess (125) of the main shipping box (123).

55. A kit (1) according to claim 54, wherein the kit (1) further comprises sectional panels (37) provided with the main and auxiliary shipping boxes (123,125), said sectional panels (37) being intended to form the specific door leaf (13) with the first components (11) of the kit (1).

56. A kit (1) according to claim 55, wherein the main and auxiliary shipping boxes (123,127) are strapped together, wherein the sectional panels (37) are pilled one onto another, and wherein the main shipping box (123) and the sectional panels (37) are strapped together, the auxiliary shipping box (127) being nested into the recess (125) of the main shipping box (123), and the main shipping box (123) being placed on top of the sectional panels (37).

57. A method of assembling a specific door assembly (23) using a kit (1) such as the one defined in claim 1.

58. A specific door assembly (23) having been assembled with a kit (1) such as the one defined in claim 1.
